(19) United States
(12) Patent Application Publication
(10) Pub. No.: US 2002/0159700 A1
(43) Pub. Date: Oct. 31, 2002

(54) Tunable filter

(76) Inventors: Trent Gary Coroy, Rancho Cucamonga, CA (US); Wenhua Lin, Pasadena, CA (US)

Correspondence Address: TRAVIS DODD, 2490 HEYNEMAN HOLLOW, FALLBROOK, CA, 92028, US

(21) Appl. No.: 09/998,379

(22) Filed: Nov. 29, 2001

Related U.S. Application Data
(63) Continuation-in-part of application No. 09/845,685, filed on Apr. 30, 2001.

(51) Int. Cl. G02B 6/26

(52) U.S. Cl. 385/39

(57) ABSTRACT

An optical filter is disclosed. The filter includes an array waveguide grating having a plurality of array waveguides. Each array waveguide is configured to receive a portion of an input light signal and output the portions of the light signal such that the portions of the light signal are combined into an output light signal. The filter also includes effective length tuners configured to change an effective length of a plurality of the array waveguides. The effective length tuners are configured to be engaged such that an angle at which the output light signal travels away from the array waveguide grating shifts relative to a reference angle. The reference angle is the angle at which the output light signal travels when the one or more effective length tuners are not engaged.

### RELATED APPLICATIONS

This application is a continuation-in-part of U.S. patent application Ser. No. 09/845,685; filed on Apr. 30, 2001; entitled “Tunable Filter” and incorporated herein in its entirety.

### BACKGROUND

1. Field of the Invention

The invention relates to one or more optical networking components. In particular, the invention relates to optical filters.

2. Background of the Invention

The wavelength division multiplexing technique allows a waveguide to carry more than one channel of information in a multichannel beam of light. Each channel is carried on a light signal associated a unique wavelength or range of wavelengths.

Filters are often employed to separate one or more of the channels from the multi-channel beam. Tunable filters allow the selection of channels that are separated from the multichannel beam to be changed. However, many of these tunable filters include moving parts that make the tunable filters difficult to integrate with other optical components. Further, the bandwidth of many of these tunable filters changes as the filter is tuned. Additionally, many tunable filters have a tuning range that is too narrow for use in an optical network or that has undesirably high power requirements.

For the above reasons, there is a need for an improved optical filter having an increased tuning range and/or reduced power requirements.

### SUMMARY OF THE INVENTION

The invention relates to an optical filter. The filter includes an array waveguide grating having a plurality of array waveguides. Each array waveguide is configured to receive a portion of an input light signal and output the portions of the light signal such that the portions of the light signal are combined into an output light signal. The filter also includes effective length tuners configured to change an effective length of a plurality of the array waveguides. The effective length tuners are configured to be engaged such that an angle at which the output light signal travels away from the array waveguide grating shifts relative to a reference angle. The reference angle is the angle at which the output light signal travels when the one or more effective length tuners are not engaged.

In some instances, the effective length tuners are also configured to be engaged so as to shift the output light signal away from the reference angle in the first direction or in a second direction.

Another embodiment of the filter includes an array waveguide grating having a plurality of array waveguides with different lengths. The filter also includes effective length tuners for changing the effective length of a plurality of the array waveguides. The effective length tuners are configured to be engaged such that the amount of effective length change for the array waveguides increases with increasing array waveguide length or such that the amount of effective length change for the array waveguides decreases with increasing array waveguide length.

In some instances, the filter includes electronics for engaging the effective length tuners such that the amount of effective length change increases with increasing array waveguide length and/or electronics for engaging the effective length tuners such that the amount of effective length change decreases with increasing array waveguide length. In one embodiment, the effective length tuners each have an effective area length that is substantially the same.

The electronics can include a plurality of resistors. At least two of the effective length tuners can each be connected in series with one or more resistors.

The resistors are selected so the resistance increases as the length of the array waveguide associated with the connected effective length tuner increases. In some instances, the resistors are selected so the resistance decreases as the length of the array waveguide associated with the connected effective length tuner increases.

At least two of the effective length tuners can each be connected in series with one or more first resistors. The first resistors and the connected effective length tuners are connected in parallel between a first line and a second line. At least two of the effective length tuners connected in series with the first resistors are also connected in series with one or more second resistors. The second resistors and the connected effective length tuners are connected in parallel between a first line and a third line.

In one embodiment of the filter, a first group of effective length tuners has an effective area length that increases with increasing array waveguide length and a second group of effective length tuners has an effective area length that decreases with increasing array waveguide length.

Yet another embodiment of the optical filter includes an array waveguide grating having array waveguides that can be associated with an array waveguide index. The array waveguide index is assigned such that the value of the array waveguide index is different for each of the array waveguides and the magnitude of the difference in the value of the array waveguide index for adjacent array waveguides is equal to 1. The filter also includes effective length tuners configured to change an effective length of a plurality of the array waveguides. The effective length tuners are configured to be engaged such that the amount of effective length change for the array waveguides increases with increasing array waveguide index or such that the amount of effective length change for the array waveguides decreases with increasing array waveguide index.

The invention also relates to a method of operating an optical filter. The method includes obtaining an optical component having a plurality of array waveguides. The method also includes combining portions of light signals traveling through the array waveguides into an output light signal traveling away from the array waveguides at an angle. The method further includes engaging a plurality of effective length tuners configured to change the effective length of the array waveguides, the effective length tuners engaged such that the output light signals are directed away from a reference angle in a first direction. The reference angle is the angle at which the light signal travels away from the array waveguides when the effective length tuners are not engaged.

In some instances, the method also includes engaging a plurality of effective length tuners such that the output light signals are directed away from the reference angle in a second direction.

### BRIEF DESCRIPTION OF THE FIGURES

FIG. 1A illustrates a filter according to the present invention.

FIG. 1B illustrates a filter having a single light distribution component.

FIG. 1C illustrates another embodiment of a filter having a single light distribution component.

FIG. 2A illustrates a filter having a light distribution component with an input side and an output side. An output waveguide is connected to the output side. A channels labeled A, B, C and D are incident on the output side of the light distribution component.

FIG. 2B illustrates the filter of FIG. 2A tuned such that the channel labeled B appears on the output waveguide.

FIG. 2C illustrates the filter of FIG. 2A tuned such that the channel labeled D appears on the output waveguide.

FIG. 2D illustrates a filter having a plurality of output waveguides. The output waveguides have inlet ports with a spacing that substantially matches that channel spacing.

FIG. 2E illustrates a filter having a plurality of output waveguides. The output waveguides have inlet ports spaced at a multiple of the channel spacing.

FIG. 2F illustrates a filter having a plurality of output waveguides. The output waveguides have inlet ports spaced at a fraction of the channel spacing.

FIG. 3A is a perspective view of an optical component including a portion of an optical filter.

FIG. 3B is a topview of an optical component having an optical filter.

FIG. 3C is a cross section of the component shown in FIG. 3B at any of the lines labeled A.

FIG. 3D is a perspective view of a portion of an optical component having a reflector.

FIG. 3E is a cross section of the component shown in FIG. 3B at any of the lines labeled A when the component includes a cladding layer.

FIG. 4A illustrates a plurality of array waveguides that each include an effective length tuner.

FIG. 4B illustrates a common effective length tuner configured to change the effective length of a plurality of array waveguides.

FIG. 4C illustrates a plurality of array waveguides that each include an effective length tuner with about the same effective area.

FIG. 5A illustrates a temperature controlled device that serves as a common effective length tuner.

FIG. 5B is a cross section of the component of FIG. 5A taken at the line labeled A.

FIG. 6A illustrates a plurality of array waveguides that each include a temperature controlled device as an effective length tuner.

FIG. 6B illustrates a temperature control device positioned over the ridge of an array waveguide.

FIG. 6C illustrates a temperature control device positioned over the ridge of an array waveguide and adjacent to the sides of the ridge.

FIG. 6D illustrates a temperature control device positioned over the ridge, adjacent to the sides of the ridge and extending away from the sides of the ridge.

FIG. 6E illustrates a plurality of array waveguides that each include a temperature controlled device as an effective length tuner. Each effective length tuner has a different resistance.

FIG. 7A illustrates a plurality of array waveguides that each include a plurality of electrical contacts that serve as an effective length tuner. Each effective length tuner includes a first electrical contact positioned over a ridge and a second electrical contact positioned under the ridge.

FIG. 7B is a cross section of FIG. 7A taken at the line labeled A.

FIG. 7C illustrates a component having a cladding layer positioned over the light transmitting medium.

FIG. 8A illustrates a plurality of array waveguides that each include a plurality of electrical contacts that serve as an effective length tuner. Each effective length tuner includes a first electrical contact positioned over a ridge and a second electrical contact positioned adjacent to a side of the ridge.

FIG. 8B is a cross section of the component shown in FIG. 8A taken at the line labeled A.

FIG. 9A illustrates a common effective length tuner including a plurality of electrical contacts. A first electrical contact positioned over ridges of the array waveguides and a second electrical contact positioned under the ridges.

FIG. 9B is a cross section of the component shown in FIG. 9A taken at the line labeled A.

FIG. 10A illustrates an optical filter having a plurality of array waveguides that each include an effective length tuner with about the same effective area. The effective length tuners are in electrical communication with electronics for tuning of the optical filter.

FIG. 10B illustrates an optical filter having a plurality of array waveguides that each include an effective length tuner with about the same effective area. The effective length tuners are in electrical communication with electronics for tuning of the optical filter so as to shift the position of a light signal on an output side of a light distribution component. The electronics are configured to shift a light signal output by the array waveguides in a first direction relative to a reference angle or in a second direction relative to the reference angle. The reference angle is the angle at which the light signal travels away from the array waveguides when the effective length tuners are not engaged.

FIG. 11A illustrates a component having a plurality of array waveguides defined in a light-transmitting medium positioned over a base. An isolation groove extending through the light transmitting medium is positioned between adjacent array waveguides.

FIG. 11B illustrates the isolation groove extending into the base.

FIG. 11C illustrates the isolation groove undercutting the array waveguides.

FIG. 11D is a topview of a component having bridge regions that each bridge an isolation groove. Electrical conductors are formed on the bridge region.

FIG. 11E is a topview of a component having a bridge region that supports a wedge shaped common effective length tuner.

FIG. 12A illustrates an effective length tuner broken into a plurality of sub effective length tuners. The sub effective length tuners are connected in series with the sub effective length tuners on an array waveguide directly connected to one another.

FIG. 12B illustrates an effective length tuner broken into a plurality of sub effective length tuners. The sub effective length tuners are connected in series with the sub effective length tuners on adjacent array waveguide directly connected to one another.

FIG. 12C illustrates an embodiment of a filter having array waveguides with more than one effective length tuner.

FIG. 12D illustrates an embodiment of a filter having array waveguides including an effective length tuner from a first group and an effective length tuner from a second group. The first group of effective length tuners is configured to shift a light signal output by the array waveguides in a first direction relative to the reference angle and the second group of effective length tuners is configured to shift the light signal in a second direction relative to the reference angle.

FIG. 12E illustrates an embodiment of the filter having more than one type of effective length tuner.

FIG. 13A illustrates a component construction having a light transmitting medium positioned over a light barrier.

FIG. 13B illustrates a component construction having a light barrier with a surface positioned between sides. A waveguide is defined adjacent to the surface of the light barrier and a light transmitting medium is positioned adjacent to the sides of the light barrier.

FIG. 13C illustrates the construction of FIG. 13B when an effective length tuner includes a plurality of electrical contacts.

FIG. 14A through FIG. 14G illustrate a method of forming an optical component having a filter.

### DETAILED DESCRIPTION OF THE PREFERRED EMBODIMENT

The invention relates to an optical filter. The filter includes a light distribution component having an input side and an output side. A plurality of array waveguides are connected to the input side and one or more output waveguides are connected to the output side. The array waveguides are configured to deliver a light signal into the light distribution component such that the light signal is incident on the output side of the light distribution component.

A plurality of the array waveguides include an effective length tuner. Each effective length tuner is configured to change the effective length of an array waveguide. The effective length tuners are configured to change the effective length of the array waveguides such that the location where the light signal is incident on the output side of the light distribution component changes. The location can be changed such that the light signal is incident on a particular output waveguide.

The filter can be employed to process a plurality of light signals that are each associated with a different wavelength. In the wavelength division multiplexing technique, each light signal is referred to as a channel. The array waveguides are configured such that each light signal is incident on the output side at a different location. The effective length tuners are configured to change the effective length of the array waveguides such that the location where each of the light signals is incident on the output side of the light distribution component changes. The locations can be changed such that one or more of the light signals are incident on an output waveguide. Accordingly, the light signal that appears on a particular output waveguide can be selected.

When the effective length tuners are not engaged, the location where the light signal is incident on the output side is the reference position. When the filter is employed to process light signals having different wavelengths, each light signal is associated with a reference position on the output side. In some instances, the effective length tuners can be engaged such that the channels are tuned in a first direction relative to the reference position(s) or in a second position relative to the reference position(s). The ability to tune in either direction relative to the reference position(s) increases the total tuning range of the optical filter. Alternatively, less power is required to tune over the same range as a filter that can tune in a single direction relative to the reference positions. As a result, the filter can provide reduced power consumption and/or an expanded tuning range.

The filter does not include any moving parts. Further, the bandwidth of the filter does not substantially change as the light signal that appears on an output waveguide changes. Accordingly, the filter overcomes the shortcomings of the prior art.

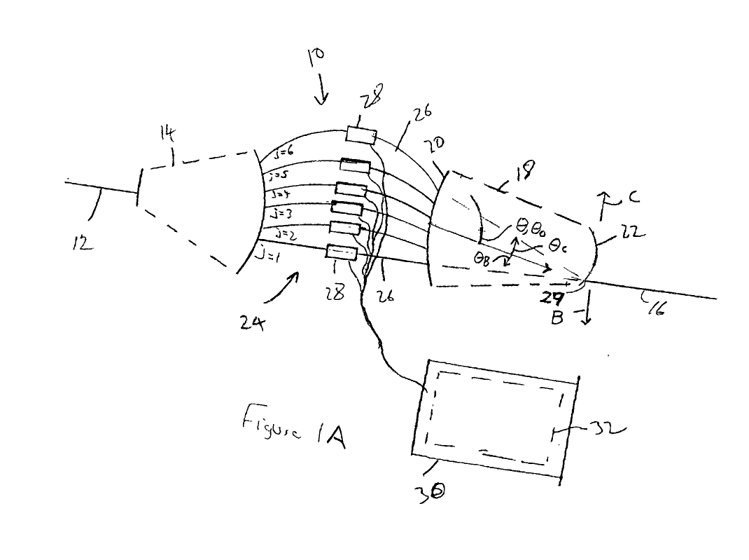

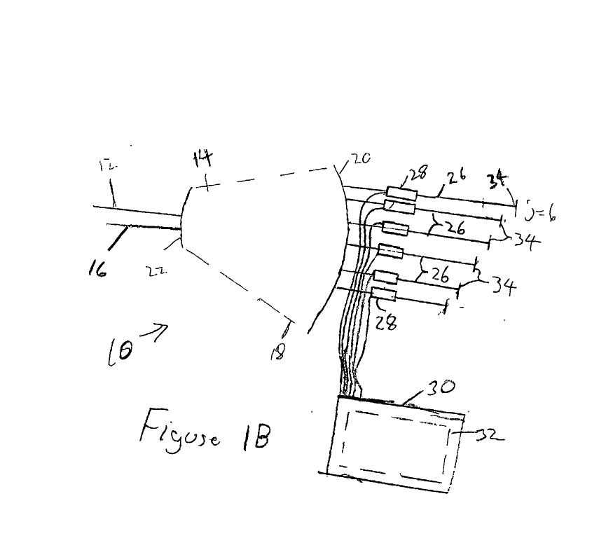

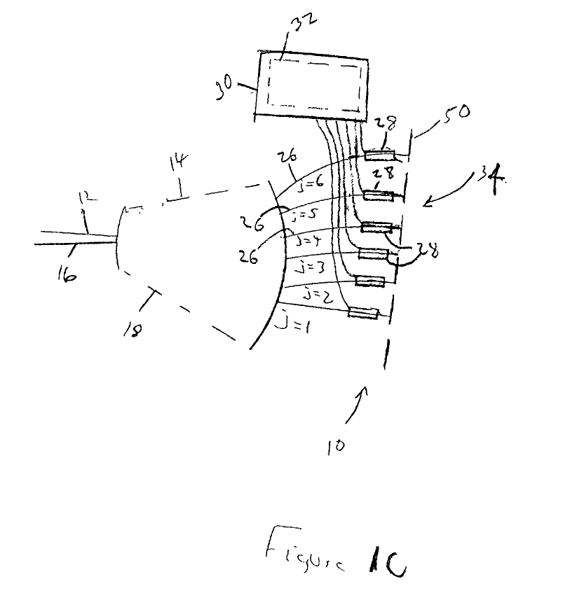

FIG. 1A illustrates an embodiment of a filter 10 according to the present invention. The filter 10 includes at least one input waveguide 12 in optical communication with a first light distribution component 14 and an output waveguide 16 in optical communication with a second light distribution component 18. The second light distribution component 18 has an input side 20 and an output side 22. A suitable first light distribution component 14 and/or second light distribution component 18 includes, but is not limited to, star couplers, Rowland circles, multi-mode interference devices, mode expanders and slab waveguides. Although a single input waveguide 12 and a single output waveguide 16 is illustrated, the filter 10 can include a plurality of input waveguides 12 and/or a plurality of output waveguides 16.

An array waveguide grating 24 connects the first light distribution component 14 and the second light distribution component 18. The array waveguide grating 24 includes a plurality of array waveguides 26. The array waveguides 26 each have a different effective length. Further, the difference in the effective length of adjacent array waveguides 26, ΔL, is a constant. Because the array waveguides 26 are often curved, the length is not consistent across the width of the array waveguide 26. As a result, the effective length is often the length averaged across the width of the array waveguide 26. Although six array waveguides 26 are illustrated, filters 10 typically include many more than six array waveguides 26 and fewer are possible. Increasing the number of array waveguides 26 can increase the degree of resolution provided by the array.

During operation of the filter 10, a light signal associated with a single wavelength enters the first light distribution component 14 from the input waveguide 12. The first light distribution component 14 distributes the light signal to the array waveguides 26. Each array waveguide 26 receives a fraction of the light signal. Each array waveguide 26 carries the received light signal fraction to the second light distribution component 18. A light signal fraction traveling through a long array waveguide 26 will take longer to enter the second light distribution component 18 than a light signal fraction light traveling through a shorter array waveguide 26. Unless the effective length differential, AL, between adjacent array waveguide 26 is a multiple of the light wavelength, the light signal fraction traveling through a long array waveguide 26 enters the second light distribution component 18 in a different phase than the light signal fraction traveling along the shorter array waveguide 26.

The light signal fraction entering the second light distribution component 18 from each of the array waveguides 26 combines to re-form the light signal. Because the array waveguide 26 causes a phase differential between the light signal fractions entering the second light distribution component 18 from adjacent array waveguides 26, the light signal is diffracted at an angle labeled, θ. The second light distribution component 18 is constructed to converge the light signal at a location on the output side 22 of the second light distribution component 18. The location where the light signal is incident on the output side 22 of the second light distribution component 18 is a function of the diffraction angle, θ. As illustrated in FIG. 1A, the phase differential provided by the array waveguide grating causes the light signal to be converged at the output waveguide 16. As a result, the output waveguide 16 carries the light signal.

When the filter 10 is employed with the wavelength division multiplexing technique, each channel to be processed by the filter 10 is associated with a different wavelength. Accordingly, each light signal to be processed by the filter 10 is associated with a different wavelength. Because the value of ΔL is a different fraction of the wavelength for each channel, the amount of the phase differential is different for different channels. As a result, different channels are diffracted at different angles and are accordingly converged at different locations on the output side 22. Hence, when light signals carrying different channels enter the second light distribution component 18, the light signals carrying different channels are converged at different locations on the output side 22. Since one of the channels can typically be converged on the output waveguide 16, the output waveguide 16 generally carries only one of the channels at a time.

A plurality of the array waveguides 26 include one or more effective length tuners 28 for tuning the effective length of the array waveguide 26. In some instances, the effective length tuners 28 are configured to increase the effective length of the array waveguides 26. In other instances, the effective length tuners 28 are configured to decrease the effective length of the array waveguides 26. In still other instances, the effective length tuners 28 can be configured to increase or decrease the effective length of the array waveguides 26. As will be described in more detail below, the filter 10 is tuned by engaging the effective length tuners 28 so as to change the effective length of a plurality of the array waveguides 28.

Although changing the effective length of an array waveguide 26 can be accomplished by changing the physical length of the array waveguide 26, other methods for changing the effective length are possible. For instance, the effective length of an array waveguide 26 can be changed by changing the amount of time required for a light signal to travel through the array waveguide 26. When the array waveguide 26 is changed so a longer time is required for a light signal to travel through the array waveguide 26, the effective length of the array waveguide 26 is increased and when the array waveguide 26 is changed so a shorter period of time is required for the light signal to travel through the array waveguide 26, the effective length is decreased. As will be discussed in more detail below, one method of changing the effective length of an array waveguide 26 is to change the index of refraction of the array waveguide 26.

Although not illustrated, a temperature electronic controller (TEC) can be employed to keep the temperature of the filter 10 at a constant level.

A controller 30 is in communication with the effective length tuners 28. The controller 30 or the filter 10 can include electronics 32 for operating the effective length tuners 28. The electronics 32 can include one or more processors. Suitable processors include, but are not limited to, programmed general purpose digital computers, microprocessors, digital signal processors (DSP), integrated circuits, application specific integrated circuits (ASICs), logic gate arrays and switching arrays.

The electronics 32 can include one or more machine readable media for storing instructions to be executed by the processor and/or for storing information to be used by the processor while executing instructions. Suitable machine readable media include, but are not limited to, RAM, electronic read-only memory (e.g., ROM, EPROM, or EEPROM), or transmission media such as digital and/or analog communication links.

The filter 10 shown in FIG. 1B can be constructed with a single light distribution component 14 by positioning reflectors 34 along the array waveguides as shown in FIG. 1A. The filter 10 includes an input waveguide 12 and an output waveguide 16 that are each connected to the output side 22 of the first light distribution component 14. The array waveguides 26 include a reflector 34 configured to reflect light signal portions back toward the light distribution component.

During operation of the filter 10, a light signal from the input waveguide 12 is distributed to the array waveguides 26. The array waveguides 26 carry the light signal portions to the reflector 34 where they are reflected back toward the first light distribution component 14. The first light distribution component combines the light signal portions so re-form the light signal and converge the light signal at the output waveguide 16. As a result, the output waveguide 16 carries the re-formed light signal.

The light signal portions travel through each array waveguide 26 twice. As a result, the light signal portions experience the effects of the effective length tuners 28 more than once. Accordingly, the effects of the effective length tuners 28 are enhanced. The enhanced effect can provide for a more efficient filter 10. For instance, the same effective length tuners 28 can provide a filter according to FIG. 1B with a larger wavelength tuning range than is achieved with a filter 10 according to FIG. 1A. Further, less power can be applied to the effective length tuners 28 of FIG. 1B than is applied to the same effective length tuners 28 used in the filter 10 of FIG. 1A to achieve the same change in the wavelength carried on the output waveguide 16.

FIG. 1C illustrates another embodiment of a filter 10 having a single light distribution component and curved array waveguides 26. The filter 10 is included on an optical component 36. The edge of the optical component 36 is shown as a dashed line. The edge of the optical component 36 can include one or more reflective coatings positioned so as to serve as reflector(s) 34 that reflect light signals from the array waveguides 26 back into the array waveguides 26. Alternatively, the edge of the optical component 36 can be smooth enough to act as a mirror that reflects light signals from the array waveguide 26 back into the array waveguide 26. The smoothness can be achieved by polishing or buffing. In some instances, the edge of the optical component is smoothed and includes one or more reflective coatings positioned so as to serve as reflector(s) 34.

An optical component 36 having a filter 10 according to FIG. 1C can be fabricated by making an optical component 36 having a filter 10 according to FIG. 1A and cleaving the optical component 36 down the center of the array waveguides 26. When the optical component 36 was symmetrical about the cleavage line, two optical components can result. Because, the light signal must travel through each array waveguide 26 twice, each resulting dispersion compensators will provide about the same dispersion compensation as would have been achieved before the optical component 36 was cleaved.

Although the filter 10 of FIG. 1B and FIG. 1C is shown with a single input waveguide 12 and a single output waveguide, the filter 10 can include a plurality of input waveguides 12 and/or a plurality of output waveguides. Although the electronics 32 are shown in FIG. 1A through FIG. 1C as being connected to each of the effective length tuners, this arrangement is often not necessary as will become evident below.

In FIG. 1A, the effective length tuners 28 are shown not engaged in that no energy is being applied to or removed from the effective length tuners 28 and there is no residual energy left from a previous engagement of the effective length tuners 28. Each array waveguide 26 is shown associated with an array waveguide index, j=1 through N. When the effective length tuners are not engaged, the effective length of waveguide j is the reference effective length, El_{j,o} and the effective length differential is the reference effective length differential, ΔLₒ, which can be determined by El_{j+l,o}EL_{j,o} where 1<j<N and N is the total number of array waveguides.

When the effective length tuners 28 are not engaged, the light signal travels away from the array waveguides 26 at a reference angle, θₒ, and is incident on the output side 22 at a reference position. The reference angle, θₒ, is shown as a partial angle because it can be measure relative to any fixed location. For instance, the reference angle, θₒ, can be measured relative to a fixed location on the input side 20 of the second light distribution component 18. The reference effective length, El_{j,o}, the effective length differential, ΔLₒ, the reference position and reference angle can be a function of temperature. For instance, temperature fluctuations can change a reference angle and accordingly a reference position. As a result, each reference effective length, El_{j,o}, the effective length differential, ΔLₒ, the reference position and reference angle can be can be associated with a temperature.

The electronics 32 shows in FIG. 1A through FIG. 1C are configured to control the effective length tuners 28 so as to change the effective length of the array waveguides 26 from the reference effective lengths, El_{j,o}. The effective length of the array waveguides 26 is changed such that the value of the effective length differential, ΔL, changes. Changing the value of the effective length differential, ΔL, changes the phase differential of the channels entering the second light distribution component 18. The changed phase differential causes the channels to be diffracted at different angles, θ, and accordingly changes the location where the channels are incident on the output side 22. As a result, the effective length tuners 28 change the location where the channels are incident on the output side 22. Further, the effective length tuners 28 can be operated so a selected channel is incident on a port 29 of the output waveguide 16. Because the output waveguide 16 will carry the channel that is incident on the port 29 of the output waveguide 16, the effective length tuners 28 can be operated so a selected channel appears on the output waveguide 16. Accordingly, the filter is tuned by changing the value of the effective length differential, ΔL.

The effective length tuners 28 are configured to change the effective length of different array waveguides 26 by a different amount. The difference in the effective length change between adjacent array waveguide 26 is the effective length change differential, δ1. The effective length tuners 28 change the effective length of the array waveguides such that the effective length change differential, δ1, is the same for each pair of adjacent array waveguides 26 having an effective length tuner. As a result, the effective length differential, ΔL=ΔLₒ+δ1.

The electronics can be employed to change the value of the effective length change differential, δ1. Because ΔL=ΔLₒ+δ1 and ΔLₒ is a constant at a particular temperature, changing the value of the effective length change differential, δ1, changes the value of the value of the effective length differential, ΔL, changes. As noted above, the filter is tuned by changing the value of the effective length differential, ΔL. As a result, operating the electronics so as to change the effective length change differential, δ1, tunes the filter.

The effective length tuners 28 can change the effective length of the array waveguides 26 so the amount of effective length change associated with an array waveguide increases as the length of the array waveguides increases. For instance, FIG. 1A illustrates an array waveguide grating 24 with 6 array waveguides labeled j =1 through j=6. The effective length tuners 28 can be configured so the change in effective length for the j-th array waveguide 26, CEL_{J}, is about Cₒ−C₁δ1+jδ1 where Cₒ is a constant that can be equal to zero and C₁ can be equal to zero or one. When the effective length tuners 28 are operated so as to increase the effective length of the array waveguides 26, δ1 is positive and the effective length differential, ΔL, increases. The increase in the effective length differential, ΔL, shifts the light signal away from the reference angle θₒ in the direction of the angle labeled θ_{c} and accordingly shifts the light signal away from the reference position in the direction of the arrow labeled C. When the effective length tuners 28 are operated so as to decrease the effective length of the array waveguides 26, δ1 is negative and the effective length differential, ΔL, decreases. The decrease in the effective length differential, ΔL, shifts the light signal away from the reference angle θₒ in the direction of the angle labeled θ_{B} and accordingly shifts the light signal away from the reference position in the direction of the arrow labeled B.

Additionally or alternatively, the effective length tuners 28 can change the effective length of the array waveguides 26 so the amount of effective length change associated with an array waveguide decreases as the length of the array waveguides increases. For instance, the effective length tuners 28 can be configured so the change in effective length for the j-th array waveguide 26, CELⱼ is about Cₒ+Cₗδ1+(N−j)δ1 where Cₒ is a constant that can be equal to zero, C₁ can be to zero or one and N is the number of array waveguides. When the effective length tuners 28 are operated so as to increase the effective length of the array waveguides 26, δ1 is positive and the effective length differential, ΔL, decreases. The decrease in the effective length differential, ΔL, shifts the light signal away from the reference angle θₒ in the direction of the angle labeled θ_{B} and accordingly shifts the light signal away from the reference position in the direction of the arrow labeled B. When the effective length tuners 28 are operated so as to decrease the effective length of the array waveguides 26, Δ1 is negative and the effective length differential, ΔL, increases. The increase in the effective length differential, ΔL, shifts the light signal away from the reference angle θₒ in the direction of the angle labeled θ_{c} and accordingly shifts the light signal away from the reference position in the direction of the arrow labeled C.

In some instances, the effective length tuners 28 can be configured to change the effective length of the array waveguides 26 so the light signal shifts away from the reference angle θₒ in the direction of the angle labeled θ_{B} or in the direction of the angle labeled θ_{c}. For instance, the effective length tuners 28 can be configured to change the effective length of the array waveguides 26 such that the amount of effective length change associated the array waveguides increases with increasing array waveguide length or such that the amount of effective length change associated with the array waveguides decreases with increasing array waveguide length. As a specific example, the effective length tuners 28 can be configured to the change effective length for the j-th array waveguide 26 is j*δ1 or (N+1−j)*δ1.

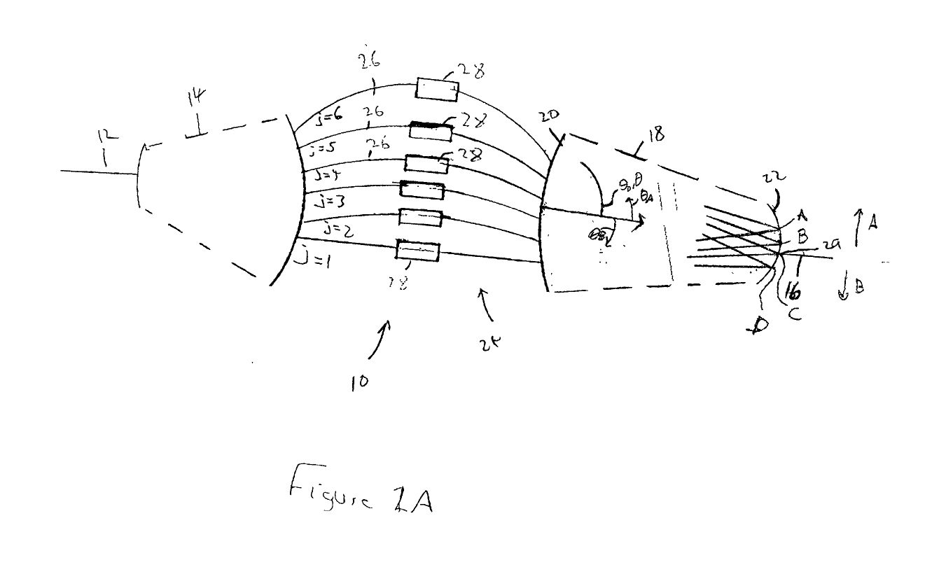

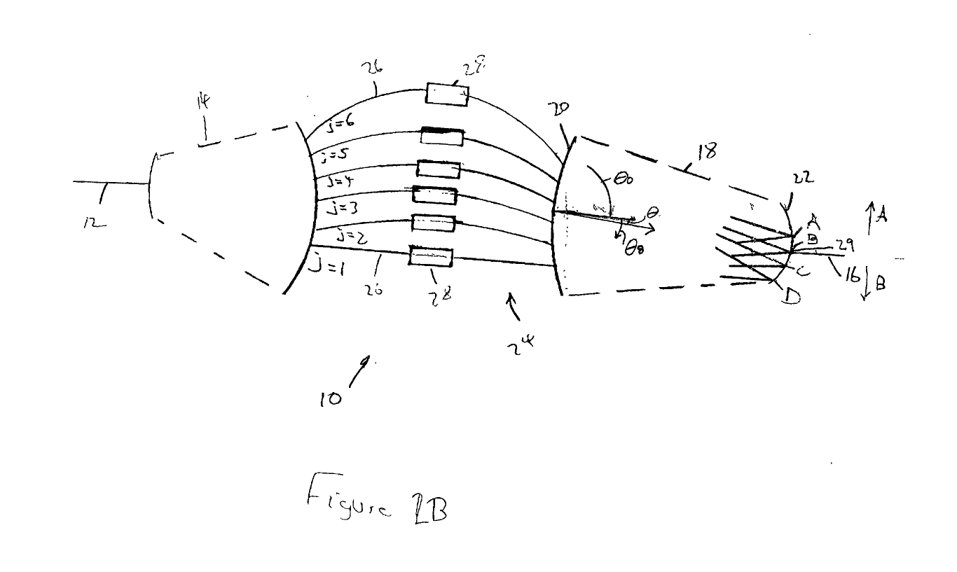

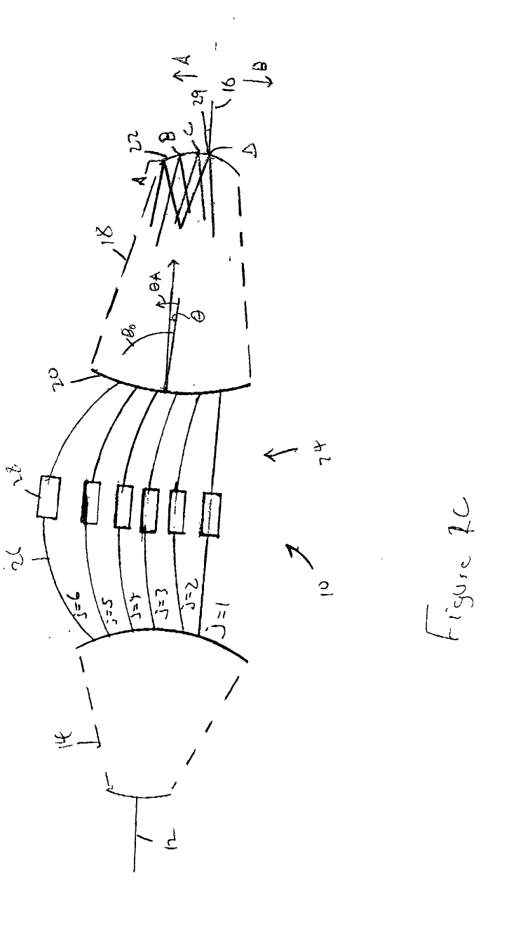

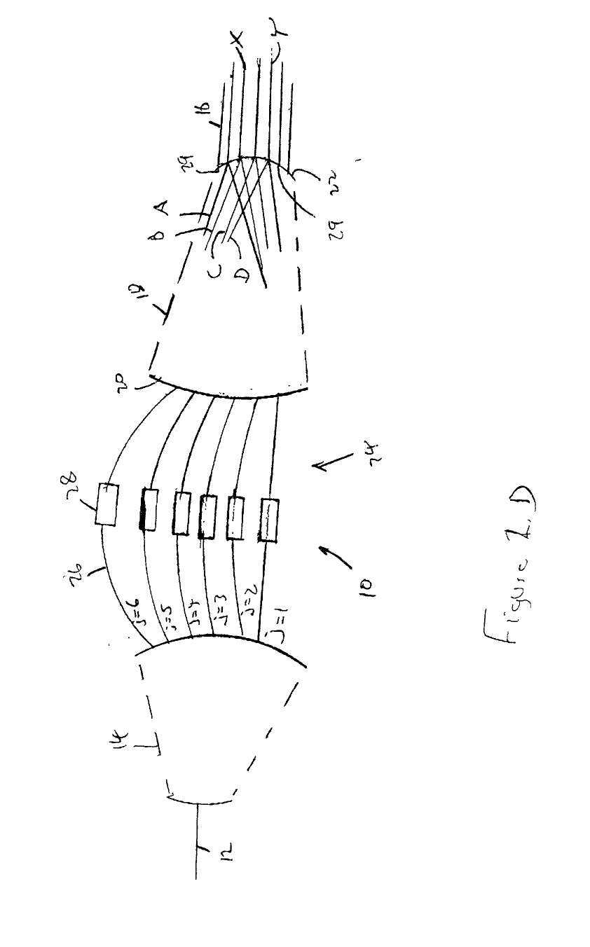

FIG. 2A through FIG. 2C illustrate tuning of the filter 10 so a particular channel appears on the output waveguide 16. FIG. 2A illustrates the filter 10 when the effective length tuners are not engaged. Accordingly, each channel illustrated in FIG. 1A travels away from the array waveguides at a reference angle and is incident at a reference position on the output side 22 of the second light distribution component 18. For the purposes of simplifying the illustration, FIG. 2A through FIG. 2B show only the angle of the channel labeled B and the reference angle for the channel labeled B. The channel labeled C is shown as being incident on the output side at the port of the output waveguide. As a result, the channel labeled C appears on the output waveguide 16.

When the effective length tuners are configured to shift the channels away from the reference angles θₒ in the direction of the angle labeled θ_{B}, the channel labeled B can be made to appear on the output waveguide as illustrated in FIG. 2B. The electronics operate the effective length tuners so as to achieve an effective length change differential that is associated with the channel labeled B appearing on the output waveguide. Each of the channels shifts in the same direction relative to the reference position. For instance, when the channel labeled B is shifted so as to be incident on the port 29 of the output waveguide 16 as shown in FIG. 2B, the channels labeled C and D shift away from the output waveguide 16 while the channel labeled A shifts toward the output waveguide.

The degree of change in the effective length change differential, δ1, affects the degree of change in the location where a channel is incident on the output side 22. For instance, operating the effective length tuners 28 so as to increase the effective length change differential, δ1, increases the shift in the location where a channel is incident on the output side 22. As a result, the channel labeled A can be made to appear on the output waveguide by operating the effective length tuners so as to increase the effective length change differential, δ1, beyond the effective length change differential, δ1, that causes the channel labeled B to appear on the output waveguide.

In some instances, the effective length tuners 28 can also be engaged so as to shift the channels away from the reference angles in the direction of the angle labeled θ_{A}. In these instances, the effective length tuners can be engaged so as to shift the channels such that the channel labeled D appears on the output waveguide as shown in FIG. 2C.

The tuning range of the optical filter is enhanced when the effective length tuners can be engaged so as to shift the channels away from the reference angles in the direction of the angle labeled OA and in the direction of the angle labeled θ_{B}. For instance, the effective length tuners can not be operated such that the channel labeled D appears on the output waveguide when the effective length tuners can only be engaged so as to shift the channels away from reference angle in the direction of the angle labeled θ_{B}. However, each of the channels can be made to appear on the output waveguide when the effective length tuners can be engaged so as to shift the channels away from the reference angles in the direction of the angle labeled θ_{A} or in the direction of the angle labeled θ_{B}, as shown in FIG. 2A through FIG. 2C. Further, because about the same amount of power is required to shift the channels in either direction relative to the reference angles, the amount of power required to achieve the same tuning range as prior filters is reduced.

The filter 10 can include more than one output waveguide 16 as shown in FIG. 2D. The filter 10 includes an output waveguide 16 labeled X, an output waveguide 16 labeled Y and a plurality of channels labeled A through D. The ports 29 of the output waveguides 16 are spaced at about the channel spacing. The channel spacing is about equal to the spacing between the locations where the channels are incident on the output side 22. As a result, each output waveguide 16 can carry a different channel. Further, the channel spacing remains substantially constant as the channels are shifted. As a result, the channels can be shifted so each of the output waveguides 16 carries a different channel than it carried before. For instance, the output waveguide 16 labeled X is illustrated as carrying the channel labeled B and the output waveguide 16 labeled Y carrying the channel labeled D. However, the effective length tuners 28 can be operated so the output waveguide 16 carry different channels. For instance, the output waveguide 16 labeled X can carry the channel labeled A and the output waveguide 16 labeled Y can carry the channel labeled C.

The output waveguides 16 can be spaced at a multiple of the channel spacing as shown in FIG. 2E. In this arrangement, a portion of the channels will not be carried on an output waveguide 16. For instance, the channel labeled C is not carried on an output waveguide 16. However, the channels can be shifted so the channel labeled C is carried on an output waveguide 16. For instance, the channels can be shifted so the channel labeled C is carried on the output waveguide 16 labeled Y and the channel labeled A is carried on the output waveguide 16 labeled Y.

The output waveguides 16 can be spaced at a fraction of the channel spacing as shown in FIG. 2F. In this arrangement, a portion of the output waveguides 16 will not carry a channel. For instance, the output waveguide 16 labeled X does not carry a channel. However, the channels can be shifted so the channel labeled X carries a channel.

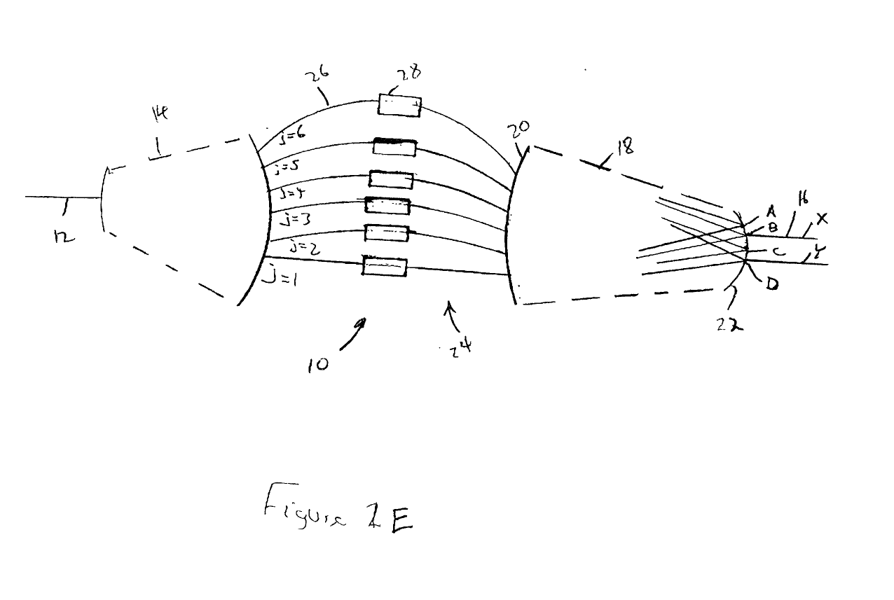

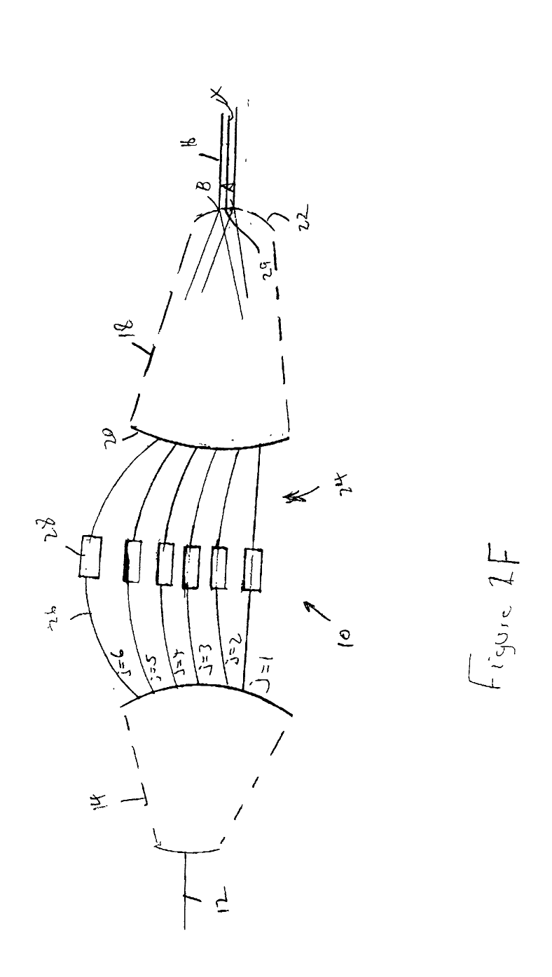

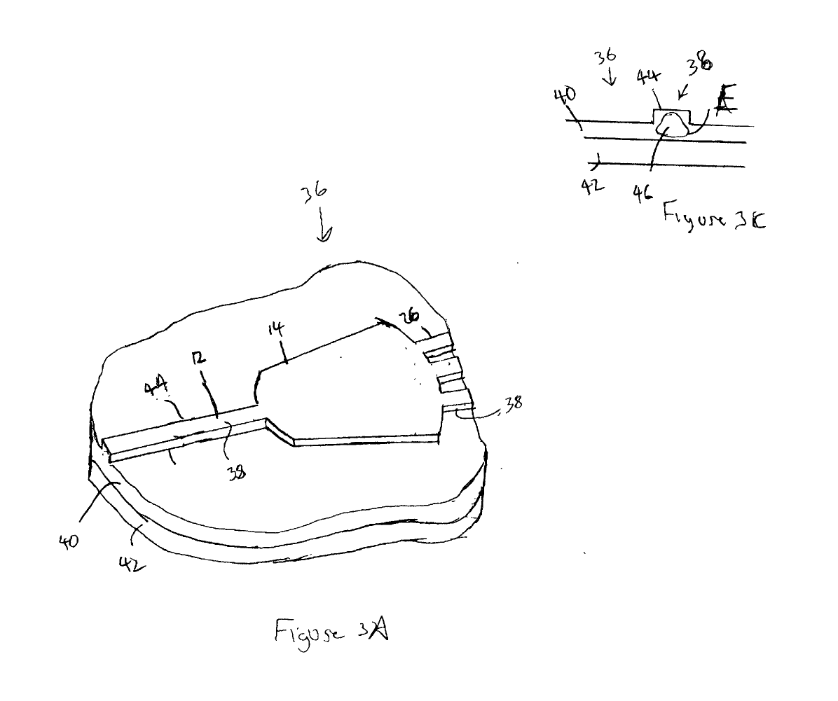

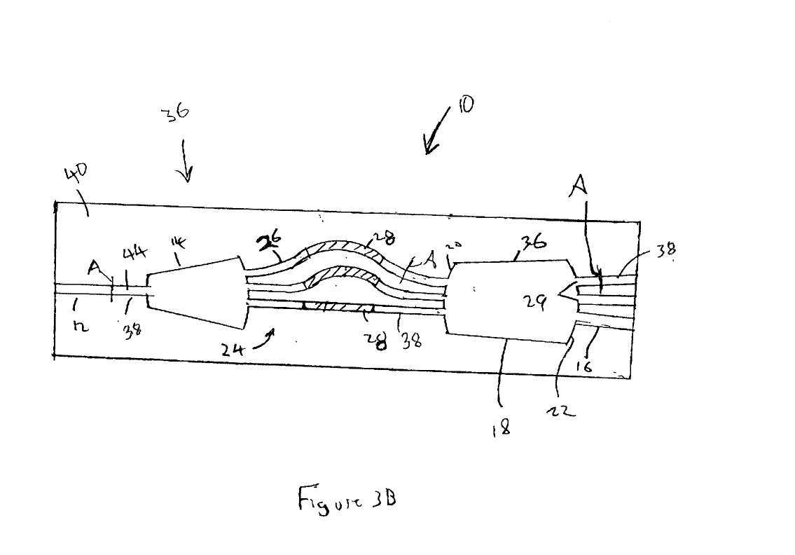

FIG. 3A illustrates a suitable construction for an optical component 36 having a filter 10 as described above. A portion of the filter 10 is shown on the component 36. The illustrated portion has a first light distribution component 14, an input waveguide 12 and a plurality of array waveguides 26. FIG. 3B is a topview of an optical component 36 having a filter 10 constructed according to FIG. 2A. FIG. 3C is a cross section of the component 36 in FIG. 3B taken at any of the lines labeled A. Accordingly, the waveguide 38 illustrated in FIG. 3C could be the cross section of an input waveguide 12, an array waveguide 26 or an output waveguide 16.

For purposes of illustration, the filter 10 in FIG. 3B is illustrated as having three array waveguides 26 and an output waveguide 16. However, array waveguide gratings 24 for use with a filter 10 can have many more than three array waveguides 26. For instance, array waveguide gratings 24 can have tens to hundreds or more array waveguides 26.

The component 36 includes a light transmitting medium 40 formed over a base 42. The light transmitting medium 40 includes a ridge 44 that defines a portion of the light signal carrying region 46 of a waveguide 38. Suitable light transmitting media include, but are not limited to, silicon, polymers, silica, SiN, LiNbO₃, GaAs and InP. As will be described in more detail below, the base 42 reflects light signals from the light signal carrying region 46 back into the light signal carrying region 46. As a result, the base 42 also defines a portion of the light signal carrying region 46. The line labeled E illustrates the profile of a light signal carried in the light signal carrying region 46 of FIG. 3C. The light signal carrying region 46 extends longitudinally through the input waveguide 12, the first light distribution component 14, each the array waveguides 26, the second light distribution component 18 and each of the output waveguides 16.

FIG. 3D illustrates a suitable construction of a reflector 34 for use with a filter 10 constructed in accordance with FIG. 1B. The reflector 34 includes a reflecting surface 47 positioned at an end of an array waveguide 26. The reflecting surface 47 is configured to reflect light signals from an array waveguide 26 back into the array waveguide 26. The reflecting surface 47 extends below the base of the ridge 44. For instance, the reflecting surface 47 can extend through the light transmitting medium 40 to the base 42 and in some instances can extend into the base 42. The reflecting surface 47 extends to the base 42 because the light signal carrying region 46 is positioned in the ridge 44 as well as below the ridge 44 as shown in FIG. 3C. As result, extending the reflecting surface 47 below the base 42 of the ridge 44 increases the portion of the light signal that is reflected.

A cladding 48 layer can be optionally be positioned over the light transmitting medium 40 as shown in FIG. 3E. The cladding 48 layer can have an index of refraction less than the index of refraction of the light transmitting medium 40 so light signals from the light transmitting medium 40 are reflected back into the light transmitting medium 40. Because the cladding 48 layer is optional, the cladding 48 layer is shown in some of the following illustrations and not shown in others.

The array waveguides 26 of FIG. 3B are shown as having a curved shape. A suitable curved waveguide 38 is taught in U.S. patent application Ser. No. 09/756,498, filed on Jan. 8, 2001, entitled “An efficient Curved Waveguide” and incorporated herein in its entirety. Other filter 10 constructions can also be employed. For instance, the principles of the invention can be applied to filters 10 having straight array waveguides 26. Filters 10 having straight array waveguides 26 are taught in U.S. patent application Ser. No. 09/724,175, filed on Nov. 28, 2000, entitled “A Compact Integrated Optics Based Array Waveguide Demultiplexer” and incorporated herein in its entirety.

The array waveguide grating 24 illustrated in FIG. 3B can be controlled so as to change the channel that appears on the output waveguide 16. Each array waveguide 26 includes an effective length tuner 28 for changing the effective length of the array waveguide 26. As will be discussed in more detail below, a variety of effective length tuners 28 can be used in conjunction with the array waveguides 26. For instance, each effective length tuner 28 can be a temperature control device such as a resistive heater. Increasing the temperature of the light transmitting medium 40 causes the index of refraction of the light transmitting medium 40 to increase and accordingly increases the effective length. Alternatively, each effective length tuner 28 can include an electrical contact configured to cause flow of an electrical current through the array waveguide 26. The electrical current causes the index of refraction of the light transmitting medium 40 to decrease and accordingly decreases the effective length. Further, each effective length tuner 28 can include an electrical contact configured to cause formation of an electrical field through the array waveguide 26. The electrical field causes the index of refraction of the light transmitting medium 40 to increase and accordingly increases the effective length.

As noted above, the effective length tuners 28 are configured to change the effective length of each array waveguide 26 by a different amount. Further, the effective lengths are changed so the effective length change differential, δ1, is the same for adjacent array waveguides 26. Because the array waveguides 26 are often curved the change in effective length is often not uniform across the width of the array waveguide 26. As a result, the change in effective length of an array waveguide 26 can be the change in the effective length averaged across the width of the array waveguide 26.

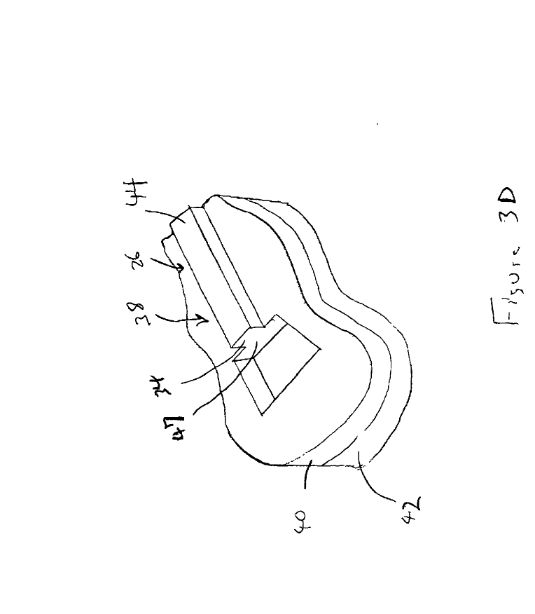

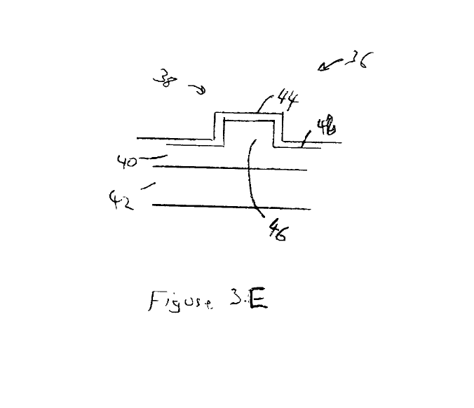

FIG. 4A illustrates one arrangement of effective length tuners 28 that electronics can engage so as to provide an effective length change differential, δ1 that is the same for each adjacent pair of array waveguides. The effective area 50 of each effective length tuner 28 is shown. The effective area 50 of an effective length tuner 28 is the area of the effective length tuner 28 that changes the effective length of the array waveguide 26. Each effective area 50 has an effective area 50 width, W, and an effective area length, L_{ELT}. The effective area 50 width, W, is about the same for each array waveguide 26. The effective area length, L_{ELT}, is different for each array waveguide 26. As a result, when the effective length tuners 28 are configured so the change in effective length per unit of effective area 50 is about the same for each effective length tuner 28, the change in effective length is different for each array waveguide 26. Although the effective length tuners 28 can be configured so the effective area length, L_{ELT}, is consistent across the width of an array waveguide 26, the effective area length, L_{ELT}, can also refer to the length of the effective area 50 averaged across the width of the array waveguide 26.

The effective length tuners 28 can be configured so the difference in the effective area 50 lengths, ΔL_{ELT}, is the same for adjacent array waveguides 26. As a result, when the effective length tuners 28 are configured so the change in effective length per unit of effective area 50 is about the same for each effective length tuner 28, the effective length change differential, δ1, is the same for adjacent array waveguides. As noted above, changing the effective length of the array waveguides 26 such that the effective length change differential, δ1, is the same for adjacent array waveguides changes the value of the effective length differential, ΔL and accordingly adjusts the location where the channels are incident on the output side 22 of the second light distribution component 18. In some instances, the difference in the effective area 50 lengths, ΔL_{ELT}, is greater than the effective length differential, ΔL.

FIG. 4B illustrates another effective length tuner 28 arrangement that can be operated so the effective length change differential, δ1 is the same for each pair of adjacent array waveguides having an effective length tuner. The effective length tuner 28 for each array waveguide 26 is incorporated into a common effective length tuner 52 that extends between the array waveguides 26. The common effective length tuner 52 can change the effective length of the portions of the component positioned between the array waveguides 26. The effective area 50 of the common effective length tuner 52 has a substantially wedge shape. The wedge shape is most effective when the array waveguides 26 are arranged so the distance between adjacent array waveguide 26 is substantially constant for different pairs of adjacent array waveguide 26. This arrangement combined with the wedge shape allows the effective area 50 of the common effective length tuner 52 to affect a different length of each array waveguide 26. Further, this arrangement encourages the difference in the average length of adjacent effective areas 50, ΔL_{ELT}, to be substantially the same for adjacent array waveguides having an effective length tuner. As a result, when the common effective length tuner 52 is engaged, the effective length change differential, δ1, is the same for adjacent array waveguides 26.

Although not illustrated, one or both sides of the effective area 50 of the common effective length tuner 52 illustrated in FIG. 4B can have a stair step shape. The stair step shape can encourage a consistent effective area 50 length across the width of the array waveguide 26.

Because a variety of non-linearities can result during operation of the effective length tuners constructed according to FIG. 4A and FIG. 4B, these embodiments may not provide the optimal tuning performance. When these constructions do not provide the optimal tuning performance, the optimal construction can be experimentally determined. The construction discussed with respect to FIG. 4A and FIG. 4B can serve as a starting point for experimentally determining the optimal construction.

FIG. 4C illustrates another effective length tuner 28 arrangement that can be operated such that the effective length change differential, δ1, is the same for adjacent array waveguides. The effective area length, L_{ELT}, is about the same for each effective length tuner 28. The effective length tuners 28 can be in communication with electronics 32 for controlling the effective length tuners 28. In some instances, the electronics are configured to control each effective length tuner independently. For instance, the electronics can be configured to cause a different amount of current to flow through different effective length tuners or to apply a different potential across different effective length tuners. As a result, the electronics can control different effective length tuner so each effective length tuner provides a different change in effective length. The changes in effective length provided by each effective length tuner can be selected such that the effective length change differential, δ1, is the same for adjacent array waveguides. The electronics 32 can tune the filter 10 by operating the effective length tuners 28 so as to change the value of the effective length change differential, δ1.

The electronics 32 can be configured to operate the effective length tuners 28 such that the effective length change to an array waveguide 26 increases as the length of the array waveguides 26 increases. For instance, the electronics 32 can be operated so the amount of current flowing through the effective length tuners 28 increases as the length of the array waveguides 26 increases or so the amount of potential applied to the effective length tuners 28 increases as the length of the array waveguides 26 increases. The increased current or potential applied to the effective length tuners associated with the longer array waveguides 26 causes a larger change in the effective length of the longer array waveguide 26 than in the shorter array waveguides 26. Additionally or alternatively, the electronics can be configured to control the effective length tuners such that the effective length change of each array waveguide decreases as the length of the array waveguides increases. An increased filter 10 tuning range results when the electronics are configured to control the effective length tuners such that the effective length change of each array waveguide decreases as the length of the array waveguides increases or such that the effective length change of each array waveguide increases as the length of the array waveguides increases. As noted above, the increased tuning range is achieved because light signals can be tuned away from the reference angle(s) in a first direction or in a second direction.

A variety of effective length tuners 28 can be employed with the arrayed waveguide 38 grating 24. A suitable effective length tuner 28 changes the index of refraction of the light transmitting medium 40. When the index of refraction of an array waveguides 26 increases, a longer time is required for the light signal to travel through the array waveguide 26. As a result, the array waveguide 26 is effectively longer. Alternatively, when the index of refraction of an array waveguides 26 decreases, a shorter time is required for the light signal to travel through the array waveguide 26. As a result, the array waveguide 26 is effectively shorter.

The effective length tuners 28 can be temperature control devices 54. The effective length increases as the temperature increases and the effective length decrease as the temperature decreases. Additionally, the amount of change in the effective length can be increased with increased temperatures or decreased with decreased temperatures. More specifically, increasing temperatures increases the change in the effective length differential, ΔL. Further, increasing the portion of an array waveguide 26 adjacent to the temperature control device 54 increases the amount of change in the effective length differential, ΔL.

A suitable temperature control devices 54 can provide only heating, only cooling or both. When the temperature control device 54 provides only heating, the temperature control device 54 can be disengaged to reduce the temperature of the array waveguide 26. When the temperature control device 54 provides only cooling, the temperature control device 54 can be disengaged to increase the temperature of the array waveguide 26. The effective area 50 of a temperature control device 54 is the area of the temperature control device 54 positioned adjacent to the array waveguide 26.

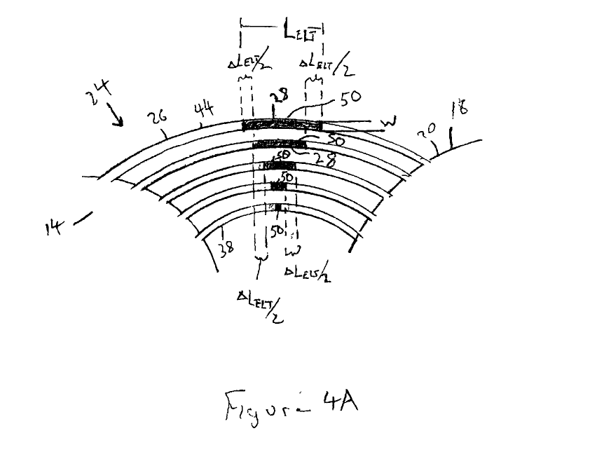

An example of a temperature control device 54 is a metal layer such as a layer of Cr, Au and NiCr. An electrical current can be flowed through the metal layer so the metal layer acts as resistive heater. FIG. 5A shows a resistive heater configured to act as a common effective length tuner 52 as discussed with respect to FIG. 4B. FIG. 5B is a cross sectional view of FIG. 5A taken at the line labeled A. The resistive heater is formed over plurality of the array waveguides 26. Electrical conductors 56 can be formed on the component 36 to deliver electrical energy to the heater. The electrical conductors 56 are in communication with pads 58 that can be connected to the controller 30 by wires. The resistive heater is configured so the temperature is substantially even across the surface. As a result, the amount of effective length change is about the same per unit of effective area 50 for each resistive heater.

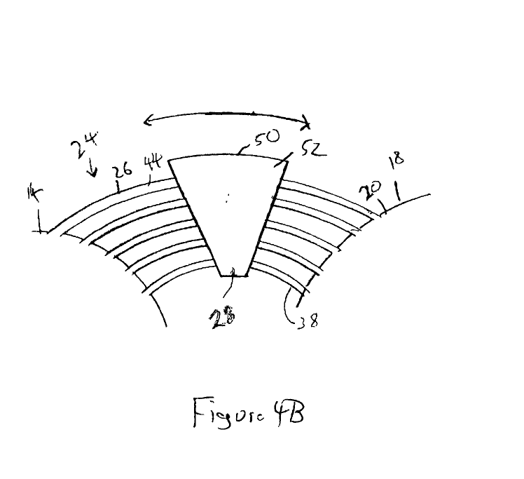

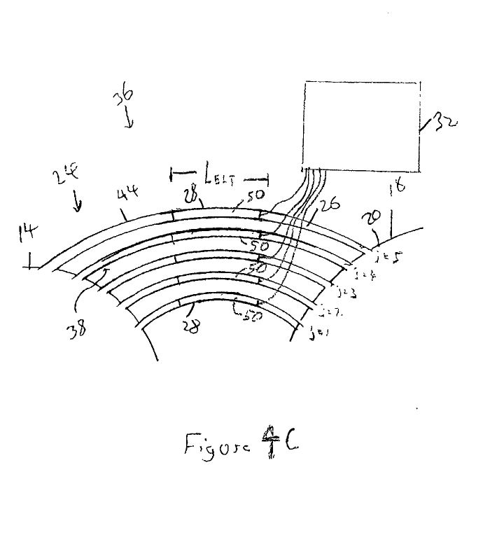

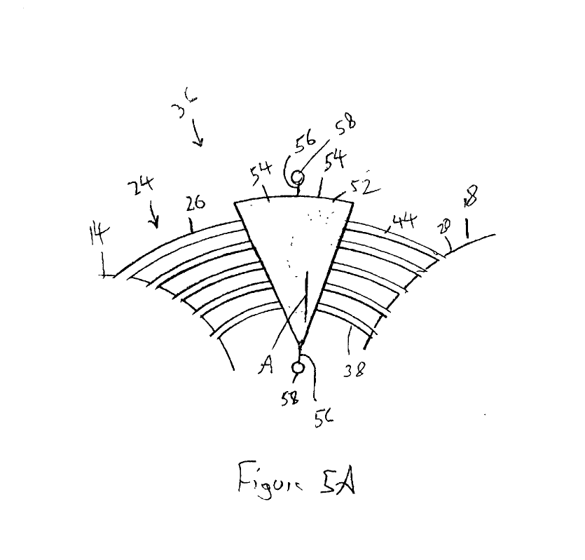

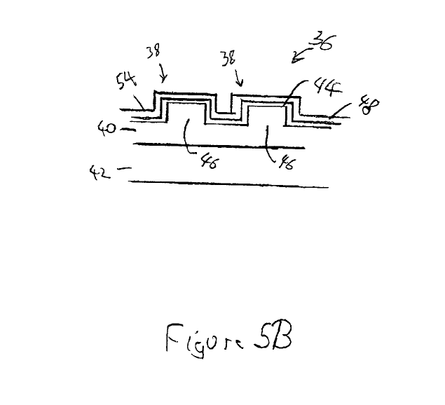

Another suitable arrangement of resistive heaters is illustrated in FIG. 6A. A resistive heater is positioned over the top 60 of the ridge 44 of each array waveguide 26. Each resistive heater can extend across the width of the ridge 44 as shown in FIG. 6B. Although the resistive heater need not extend across the entire width of the ridge 44, extending the resistive heater across the width of the ridge 44 helps preserve the uniformity of change in the index of refraction across the width of the array waveguide 26.

The resistive heater can be positioned adjacent to the sides 62 of the ridge 44 as shown in FIG. 6C in order to increase the portion of the light signal carrying region 46 exposed to the temperature change. Further, the resistive heater can extend away from the sides 62 of the ridge 44 as shown in FIG. 6D. Extending the resistive heater away from the sides 62 of the ridge 44 further increases the portion of the light signal carrying region 46 exposed to the temperature change.

FIG. 6A shows the resistive heaters connected in series by a series of electrical conductors 56. When the electronics apply a potential between the pads 58, a current flow through the resistive heaters. Because the resistive heaters are connected in series, the same current flows through each resistive heater. When the metal layer of each resistive heater has about the same thickness and each resistive heater has the same position relative to the array waveguide 26, the degree of heating per unit of effective area 50 of the resistive heater is about the same for each resistive heater. More specifically, the temperature of each resistive heater is about the same. As a result, the amount of effective length change is about the same per unit of effective area 50 for each resistive heater.

As noted above, the degree of the effective length change increases as the temperature increases. As a result, the temperature of the resistive heaters is controlled in order to tune the filter 10. For instance, when the effective length tuners 28 of FIG. 2A are resistive heaters arranged such that the total change in effective length for the j-th array waveguide 26 is j*Δ1, a higher temperature is needed to make the channel labeled A appear on the output waveguide 16 than is required to make the channel labeled B appear on the output waveguide 16.

When a temperature control device 54 is employed as an effective length tuner 28, Equation 1 can be used to approximate the tuning range, Δλ, of the filter 10. The tuning range is the range of wavelengths over which the filter 10 can be tuned. In Equation 1, λ₁ is the lowest wavelength in the tuning range. Δn_{T} is the total change in the index of refraction of the light transmitting medium caused by the temperature change. Δn_{T} can be expressed as dn_{T}/dT * ΔT where dn_{T}/dT is the coefficient of thermal expansion of the light transmitting medium 40. The coefficient of thermal expansion measures the change in the index of refraction of the light transmitting medium 40 that occurs with a 1 degree change in temperature. ΔT is the total temperature change needed for the wavelength tuning range, Δλ.

Δλ=(Δn_{T}* ΔL_{ELT}*λ₁)/(ΔL) Equation 1

Equation 1 illustrates that increasing the value of ΔL_{ELT} can increase the tuning range. Additionally, an increased thermal coefficient increases the tuning range. The thermal coefficient is dependent on the light transmitting medium 40 that is chosen. For example, the thermal coefficient for Silicon is about 0.0002/° C.; polymer is about 0.00018 /° C.; LiNbO₃ is about 0.000053 /° C.; and silica is about 0.00001 /° C.

In some instances, the temperature of the effective length tuners 28 is used to control the filter 10. The filter 10 can include one or more temperature sensors such as thermocouples in order provide for control of the temperature of the effective length tuners 28. Suitable locations for the temperature sensors include the top 60 or sides 62 of the ridges of the array waveguides 26, the cladding 48 layer, under the effective length tuner 28 or over the effective length tuner 28. The output of the one or more temperature sensors can be monitored by the electronics 32. The electronics 32 can use the output in a feedback control loop in order to keep the effective length tuners 28 and/or the array waveguides 26 at a particular temperature.

When the effective length tuners 28 are temperature control devices 54, the filter 10 can be controlled from calibration data. For instance, the TEC can be employed to hold the filter 10 at a constant temperature. The wavelength and/or channel that appears on the output waveguide 16 can be monitored as the temperature of the temperature controlled devices is changed. The generated data can then be used to determine a relationship between the wavelength (or channel) and the temperature of the temperature control device 54. The relationship can be expressed by a mathematical equation generated by performing a curve fit to the data. Alternatively, the relationship can be expressed in a tabular form.

During operation of the filter 10, the TEC is employed to hold the filter 10 at the temperature at which the calibration data was generated. The relationship is used to identify the temperature associated with the wavelength that is desired to appear on the output waveguide 16. The temperature control device 54(s) are then operated so as to achieve the desired temperature.

When the temperature control device 54(s) are resistive heaters, calibration data can be generated using the current through the resistive heaters as an alternative to using the temperature of the temperature control devices 54. For instance, the wavelength and/or channel that appears on the output waveguide 16 can be monitored as the current through the resistive heater is changed. The generated data can then be used to determine a relationship between the wavelength (or channel) and the current. During operation of the filter 10, the TEC is employed to hold the filter 10 at the temperature at which the calibration data was generated. The relationship is used to identify the current associated with the wavelength that is desired to appear on the output waveguide 16. The temperature control device(s) 54 are then operated at the identified current.

FIG. 6E illustrates another suitable arrangement of resistive heaters. Resistive heaters connected in series are positioned over the top 60 of the ridge 44 of each array waveguide 26. Each of the resistive heaters has about the same length while having a different resistance. A suitable method for controlling the resistance of different resistive heaters includes, but is not limited to, forming each resistive heater of a metal layer having a different thickness. Thicker resistive heaters provide less resistance than thinner resistive heaters. When the electronics 32 apply a potential between the pads 58, the different resistances causes different resistive heaters to heat to different temperatures. As a result, the effective length change to different array waveguides 26 is different. The resistance associated with each resistive heater is selected such that when the electronics apply a potential between the pads 58, the difference in change the effective length of adjacent array waveguides 26 is about the same. Electronics can change the potential applied between the pads to tune the filter.

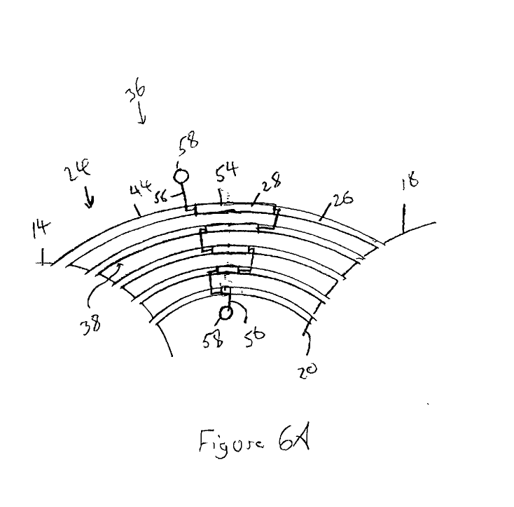

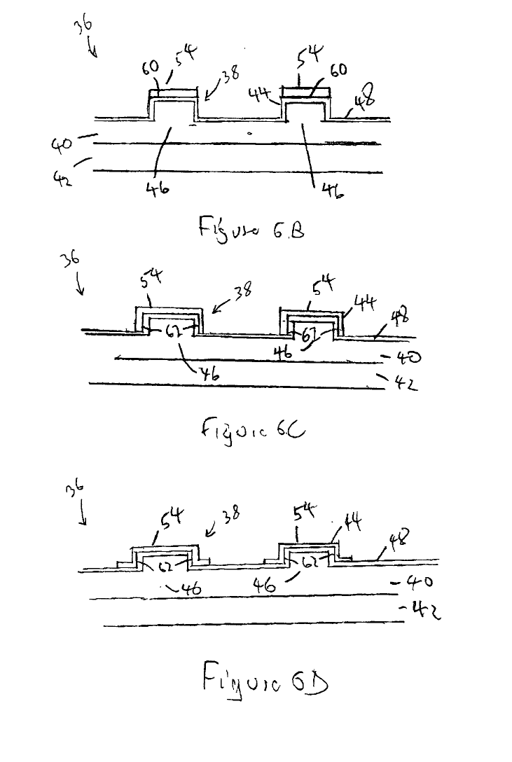

The effective length tuners 28 can also include electrical contacts 64. FIG. 7A is a topview of a component 36 having effective length tuners 28 including a first electrical contact 64A and a second electrical contact 64B. FIG. 7B is a cross section of the component 36 shown in FIG. 7A taken at the line labeled A. The effective length tuners 28 include a first electrical contact 64A positioned over the ridge 44 and a second electrical contact 64B positioned under the ridge 44 on the opposite side of the component 36. A doped region 66 is formed adjacent to each of the electrical contacts 64. The doped regions 66 can be N-type material or P-type material. When one doped region 66 is an N-type material, the other doped region 66 is a P-type material. For instance, the doped region 66 adjacent to the first electrical contact 64A can be a P type material while the material adjacent to the second electrical contact 64B can be an N type material. In some instances, the regions of N type material and/or P type material are formed to a concentration of 10⁽¹⁷⁻²¹⁾/cm³ at a thickness of less than 6 μm, 4 μm, 2 μm, 1 μm or 0.5 μm. The doped region 66 can be formed by implantation or impurity diffusion techniques.

During operation of the effective length tuner, a potential is applied between the electrical contacts 64. The potential causes the index of refraction of the first light transmitting medium 40 positioned between the electrical contacts 64 to change as shown by the lines labeled B. As illustrated by the lines labeled B, the effective area 50 of each effective length tuner 28 is about equal to the portion of the first electrical contact 64A adjacent to the array waveguide 26.

When the potential on the electrical contact 64 adjacent to the P-type material is less than the potential on the electrical contact 64 adjacent to the N-type material, a current flows through the light transmitting medium 40 and the index of refraction decreases. The reduced index of refraction decreases the effective length of the array waveguides 26. When the potential on the index changing element adjacent to the P-type material is greater than the potential on the index changing element adjacent to the N-type material, an electrical field is formed between the index changing elements and the index of refraction increases. The increased index of refraction increases the effective length of the array waveguide 26. As a result, the controller 30 can change from increasing the effective length of the array waveguides 26 to decreasing the effective length of the array waveguides 26 by changing the polarity on the first electrical contact 64A and the second electrical contact 64B.

Increasing the potential applied between the electrical contacts 64 increases the amount of effective length change. For instance, when the effective length tuner 28 is being employed to increase the effective length of an array waveguide 26, increasing the potential applied between the electrical contacts 64 further increases the effective length of the array waveguide 26. Additionally, increasing the size of the first electrical contacts 64A to cover a larger area of the array waveguides 26 can increase the amount of effective length change although a larger potential may be required.

Each of the first electrical contacts 64A and the second electrical contacts 64B can be connected in series as shown in FIG. 7A. The doped regions 66 need not extend under the electrical conductor 56 connecting the electrical contacts 64. Connecting the first electrical contacts 64A in series causes the amount of current flow per unit of effective area 50 of first electrical contact 64A to be about the same for each set of electrical contacts 64. As a result, the amount of effective length change per unit of effective area 50 is about the same for each first electrical contact 64A.

As noted above, the degree of the effective length change increases as the applied potential increases. As a result, the applied potential is controlled so as to tune the filter 10. For instance, when the effective length tuners 28 of FIG. 2A include a first electrical contact 64A and a second electrical contact 64B arranged such that the total change in effective length for the j-th array waveguide 26 is j*Δ1, a higher potential is needed to make the channel labeled A appear on the output waveguide 16 than is required to make the channel labeled B appear on the output waveguide 16.

When the effective length tuners 28 include electrical contacts 64, Equation 2 can be used to determine the tuning range, Δλ, of the filter 10. In Equation 2, λ₁ is the lowest wavelength in the tuning range; Δn_{E} is the total change in the index of refraction of the light transmitting medium that results from the current injection or the applied electrical field change. Δn_{E} can be expressed as dn_{E}/dN*ΔN where ΔN is the total carrier density change needed for the tuning range Δλ and dn_{E}/dN measures the change in the index of refraction of the light transmitting medium 40 that occurs per unit of carrier density change. Equation 2 illustrates that increasing the value of ΔL_{ELT} can increase the tuning range. Additionally, increasing Δn_{E}, dn_{E}/dN or ΔN can increase the tuning range.

Δλ=(Δn_{E}*ΔL_{ELT}*λ₁)/(ΔL) Equation 2

The tuning range of effective length tuners 28 that include electrical contacts 64 can be limited by free carrier absorption that develops when higher potentials are applied between the electrical contacts 64. Free carrier absorption can cause optical loss. Increasing ΔL_{ELT} can increase the tuning range without encouraging free carrier issues. Additionally, choosing a light transmitting medium 40 with an index of refraction that is highly responsive to current or electrical fields can also improve the tuning range.

The second electrical contact 64B can have about the same width as the first electrical contact 64A as shown in FIG. 7B. Alternatively, the second electrical contact 64B can have a width that is greater than the width of the first electrical contact 64A as shown in FIG. 7C. The additional width of the second electrical contact 64B can help to distribute the region where the index of refraction changes more evenly through the light signal carrying region 46.

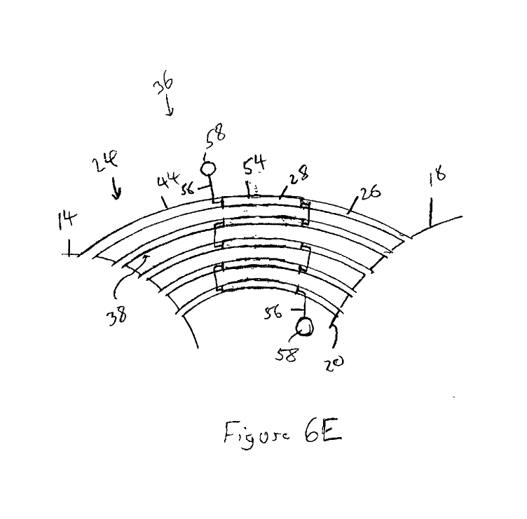

The second electrical contact 64B need not be positioned under the ridge 44 as shown in FIG. 8A through FIG. 8B. FIG. 8A is a topview of a component 36 having first electrical contact 64A positioned over the ridges 44 of the array waveguides 26 and FIG. 8B is a cross section of the component 36 of FIG. 8A taken at the line labeled A. This arrangement causes the index of refraction to be changed in the region indicated by the lines labeled B.

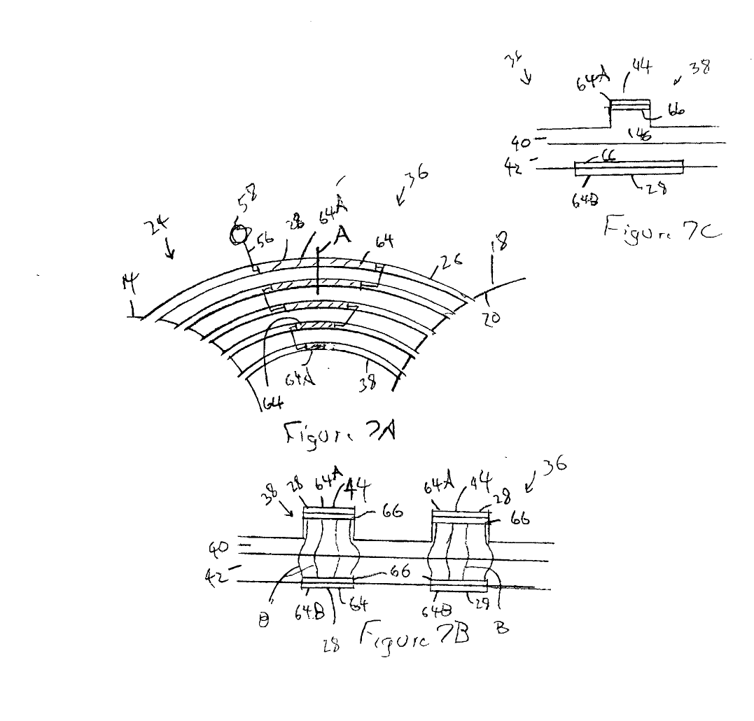

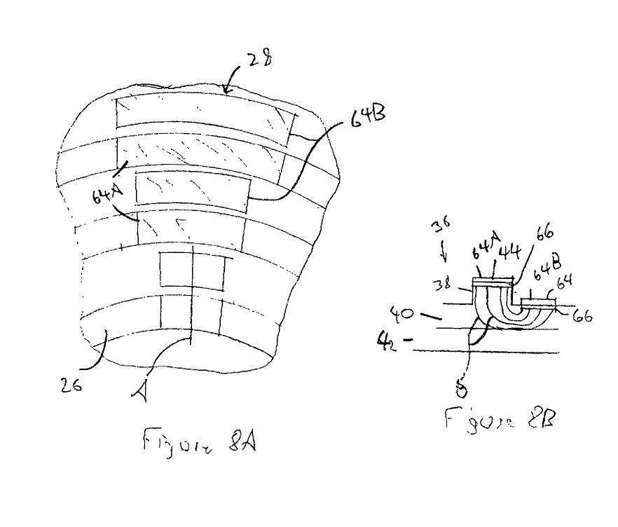

FIG. 9A and FIG. 9B show the first electrical contact 64A and the second electrical contact 64B configured to act as common effective length tuner 52 as discussed above in respect to FIG. 4B. FIG. 9A is a topview of a component 36 having a first electrical contact 64A extending over a plurality of the array waveguides 26 and FIG. 9B is a cross section of FIG. 9A taken at the line labeled A. Although the shape of the second electrical contact 64B is not illustrated, the second electrical contact 64B can have a shape that mirrors the shape of the first electrical contact 64A. The dimensions of the second electrical contact 64B need not be the same as the dimensions of the first electrical contact 64A. For instance, the second electrical contact 64B can have larger dimensions than the first electrical contact 64A while retaining a shape that mirrors the first electrical contact 64A. The doped regions 66 are formed under the entire first electrical contact 64A and the entire second electrical contact 64B.

The first electrical contact 64A has a wedge shape. Although not illustrated, one or both sides of the wedge can have a stair step shape. The stair step shape can encourage a consistent effective area 50 length across the width of the array waveguide 26.

The electrical contacts 64 can also serve as a temperature controlled device. For instance, the doped regions 66 can be eliminated. When enough potential is applied between the electrical contacts 64, a current will flow through the light transmitting medium 40 and increase the temperature of the light transmitting medium 40. Accordingly, the electrical contacts 64 can serve as a heater.

When the effective length tuners 28 include electrical contacts 64, the filter 10 can be controlled from calibration data. For instance, the TEC can be employed to hold the filter 10 at a constant temperature. The wavelength and/or channel that appears on the output waveguide 16 is monitored as the potential on the electrical contacts 64 is changed. The generated data is used to determine a relationship between the wavelength (or channel) and the applied potential. The relationship can be expressed by a mathematical equation generated by performing a curve fit to the data. Alternatively, the relationship can be expressed in a tabular form.

During operation of the filter 10, the TEC is employed to hold the filter 10 at the temperature at which the calibration data was generated. The relationship is used to identify the potential associated with the wavelength that is desired to appear on the output waveguide 16. The effective length tuners 28 are then operated at the desired potential.

Other effective length tuners are possible. For instance, the index of refraction of a light transmitting medium often changes in response to application of a force to the light transmitting medium. As a result, the effective length tuner can apply a force to the light transmitting medium. A suitable device for application of a force to the light transmitting medium is a piezoelectric crystal. The index of refraction of a light transmitting medium also changes in response to application of magnet to the light transmitting medium. As a result, the effective length tuner can apply a tunable magnetic field to the light transmitting medium. A suitable device for application of a magnetic field to the light transmitting medium is a magnetic-optic crystal.

The effective length tuners 28 need not be constructed to produce a change in effective length per unit of effective area 50 that is about the same for each effective length tuner 28. For instance, the controller 30 can independently control each effective length tuner 28. The controller 30 can control the effective length tuners 28 so different effective length tuners 28 have a different change in effective length per unit of effective area 50. For instance, when the effective length tuners 28 are temperature controlled devices the controller 30 can control the effective length tuners 28 so different effective length tuners 28 have different temperatures. As a result, the constant ΔL_{ELT} need not be retained. For instance, each effective length tuner 28 can have about the same effective area 50 as noted with respect to FIG. 4C. In order to preserve the constant ΔL, effective length tuners 28 where a larger change in effective length is needed are increased to higher temperatures than effective length tuners 28 where a lower change in effective length is needed.

When the effective length tuners 28 include sets of electrical contacts 64, the controller 30 can control the effective length tuners 28 so a different amount of current flows through different effective length tuners 28. As a result, the constant ΔL_{ELT} need not be retained. For instance, each effective length tuner 28 can have about the same effective area 50 as noted with respect to FIG. 4C. However, effective length tuners 28 where a larger change in effective length is needed can be operated at higher currents than effective length tuners 28 where a lower change in effective length is needed.

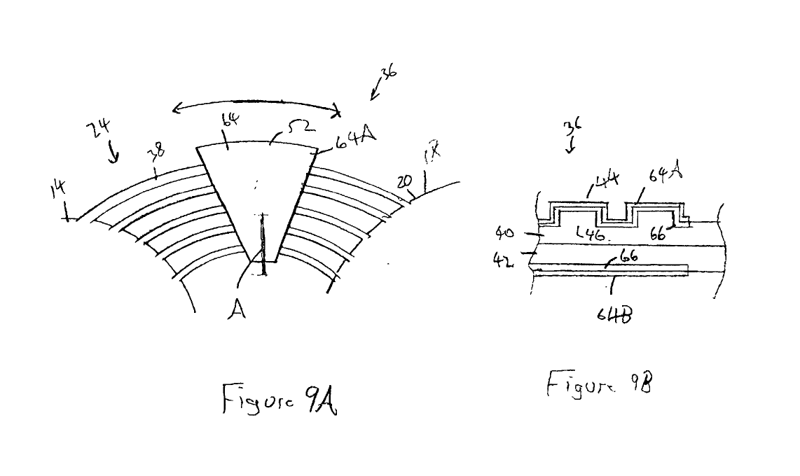

FIG. 10A illustrates a portion of the electronics 32 suitable for use with the effective length tuners arranged in accordance with FIG. 4C. The effective length tuners 28 that are suitable for use with the illustrated arrangement can be electronically driven such as temperature control devices and electrical contacts. The effective area length, L_{ELT}, is about the same for each effective length tuner 28. As a result, the amount of effective length change resulting from applying the same amount of energy to each effective length tuners 28 is about the same for each array waveguide 26.

The electronics 32 include a first line 68A and a second line 68B. The effective length tuners 28 are connected in parallel between the first line 68A and the second line 68B. One or more resistors 69 are positioned between each effective length tuner 28 and the first line 68A. Accordingly, each resistor 69 is associated with an effective length tuner 28 and an array waveguide 26. The illustrated electronics 32 can be positioned on the filter 10 using known integrated circuit manufacturing techniques or can be remote from the filter 10. When the electronics 32 are positioned on the filter 10, the electronics 32 can include one or more pads for connecting providing optical communication with the remainder of the electronics 32 in the controller 30.

During operation of the effective length tuners 28, a potential is applied between the first line 68A and the second line 68B so as to drive a current through the effective length tuners 28. Resistors 69 associated with different effective length tuners 28 can provide different levels of resistance. Resistors 69 providing more resistance will have a smaller amount of current flowing through the associated effective length tuners 28. The reduced current results in a smaller change in effective length for the associated array waveguide 26.

The resistors 69 can be selected so as to produce a constant effective length change differential, δ1. For instance, if the amount of effective length change caused by an effective length tuner 28 is substantially a linear function of the current through the effective length tuner 28, the resistors 69 can be selected such that Rⱼ=C/j or Rⱼ=C/(N−j+1), where j is the array waveguide index, Rⱼ the total resistance of the one or more resistors 69 associated with array waveguide j, C is a positive constant, N is the total number of array waveguides 26 that are associated with a resistor 69. It is noted that the amount of effective length change caused by an effective length tuner 28 is often not substantially a linear function of the current through the effective length tuner 28. In these instances, the amount of resistance for the one or more resistors 69 associated with each effective length tuner 28 can be experimentally determined or can be approximated using simulation programs.

Additionally, the resistors 69 can be selected so as to control the tuning direction that results from engaging the effective length tuners 28. For instance, the resistors 69 can be selected so the total resistance associated with an effective length tuner 28 decreases as the length of the associated array waveguides 26 increases. This design causes more current flow through effective length tuners 28 associated with longer array waveguides 26 than shorter array waveguides 26. As a result, the amount of effective length change increases as the length of the array waveguides 26 increases. When engaging the effective length tuners 28 increases the effective length of the array waveguides 26, engaging the effective length tuners 28 shifts the light signals away from the reference angle θₒ in the direction of the angle labeled θ_{A}. When the resistors 69 are selected so the resistance increases as the length of the associated array waveguides 26 increases and engaging the effective length tuners 28 increases the effective length of the array waveguides 26, engaging the effective length tuners 28 would shift the light signals away from the reference angle θₒ in the direction of the angle labeled θ_{B}.

The filter 10 is tuned by varying the potential applied between the first line 68A and the second line 68B. Changing the potential changes the value of effective length change differential, δ1 and accordingly causes shifting in the position of the light signals on the output side 22.

The resistors 69 can be tunable. Tunable resistors 69 can be used to experimentally determine the optimal resistance for the fixed resistors 69. After the optimal resistance is determined, subsequent filters 10 can be fabricated using fixed resistors 69 with the determined resistance. Tunable resistors 69 can also be used to optimize performance of the filter 10. For instance, the controller 30 can maintain resistor settings associated with particular filter output. When a particular filter output is desired, the controller 30 can adjust the potential and the resistances to the desired settings. Tunable resistors 69 can also be used to tune the filter 10. For instance, the resistors 69 can be tuned such that the effective length change differential, δ1, changes while the potential remains constant. The change in the effective length change differential, δ1, causes the position of the light signals on the output side 22 to shift.

FIG. 10B illustrates an embodiment of the electronics 32 configured to control the effective length tuners 28 such that the effective length change of each array waveguide 26 increases as length of the array waveguides increases or decreases as the length of the array waveguides 26 increases. As a result, the effective length tuners can be operated so as to shift the light signals away from the reference angle, θₒ, in the direction of the angle labeled θ_{A} or in the direction of the angle labeled θ_{B}. The effective area length, L_{ELT}, is about the same for each effective length tuner 28. The electronics 32 include a first line 68A, a second line 68B and a third line 68C. The effective length tuners 28 are connected in parallel between the first line 68A and the second line 68B. The effective length tuners 28 are also connected in parallel between the second line 68B and the third line 68C. The electronics 32 also includes a plurality of first resistors 69A and a plurality of second resistors 69B. A first resistor 69A is positioned between each effective length tuner 28 and the first line 68A and a second resistor 69B is positioned between each effective length tuner 28 and the third line 68C. The illustrated electronics 32 can be positioned on the filter 10 using known integrated circuit manufacturing techniques or can be remote from the filter 10.

The effective length tuners 28 can be engaged by applying a potential between the first line 68A and the second line 68B or between the second line 68B and the third line 68C. When the potential is applied between the first line 68A and the second line 68B, the resulting current flows through the first resistors 69A. When the potential is applied between the third line 68C and the second line 68B, the current flows through the second resistors 69B.

The first resistors 69A are selected so as to produce a constant effective length change differential, δ1. Additionally, the first resistors 69A are selected so the resistance decreases as the length of the associated array waveguides increases. When engaging the effective length tuners 28 increases the effective length of the array waveguides and a potential is applied between the first line and the second line, the effective length tuners shifts the light signals away from the reference angle, θₒ, in the direction of the angle labeled θ_{A}. The second resistors 69B are also selected so as to produce a constant effective length change differential, δ1. Additionally, the second resistors 69B are selected so the resistance increases as the length of the associated array waveguides 26 increases. When engaging the effective length tuners 28 increases the effective length of the array waveguides 26 and a potential is applied between the third line 68C and the second line 68B, the effective length tuners 28 shifts the light signals away from the reference angle, θₒ, in the direction of the angle labeled θ_{B}. Accordingly, applying a potential between the first line 68A and the second line 68B shifts the light signals away from the reference angle in a first direction while applying a potential between the third line 68C and the second line 68B shifts the light signals away from the reference angle in a second direction. Hence, the tuning direction can be selected based on the selection of lines to which the potential is applied.

As noted with respect to FIG. 10A, the resistors 69 can be tunable. Accordingly, the first resistors 69A and/or the second resistors 69B can be tunable.

Suitable effective length tuners 28 for use with the arrangement illustrated in FIG. 10A or FIG. 10B include, but are not limited to, temperature control devices, piezoelectric devices and electrical contacts. When the effective length tuners each include a plurality of electrical contacts, the second line 68B can be in electrical communication with each of the second electrical contacts while the first line 68A is in electrical communication with each of the first electrical contacts. Alternatively, the second line 68B can be in electrical communication with each of the second electrical contacts while the first line 68A and the third line 68C are in electrical communication with each of the first electrical contacts. Because the second electrical contact and the first electrical contact can be positioned on opposing sides of the filter 10, the lines can be positioned on opposing sides of the filter.

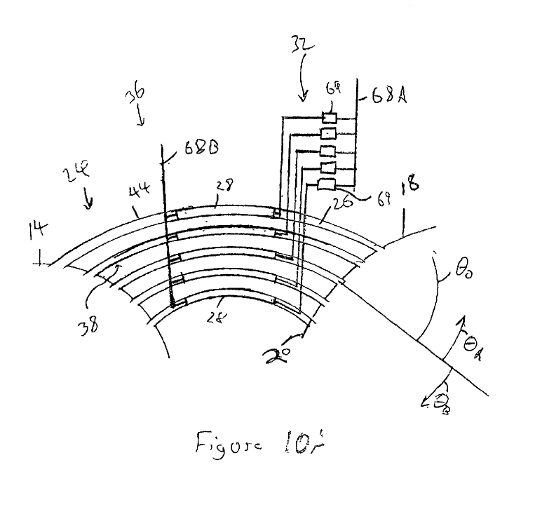

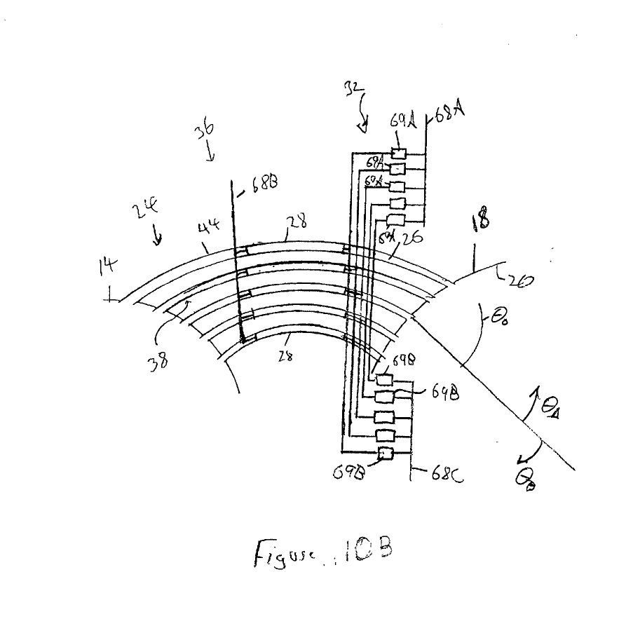

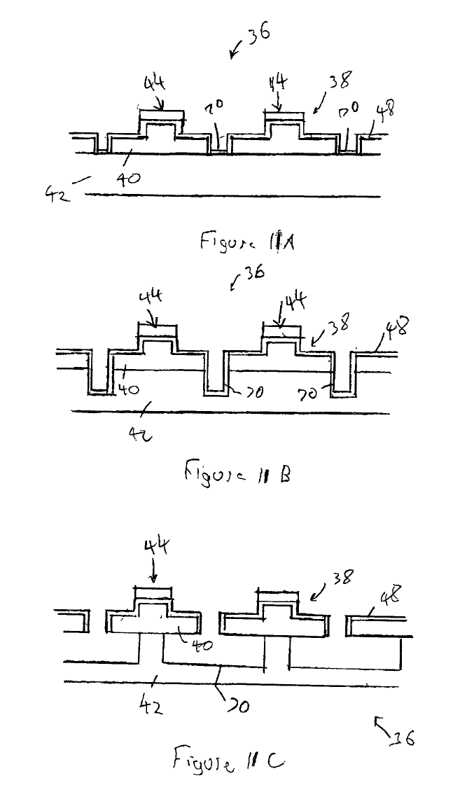

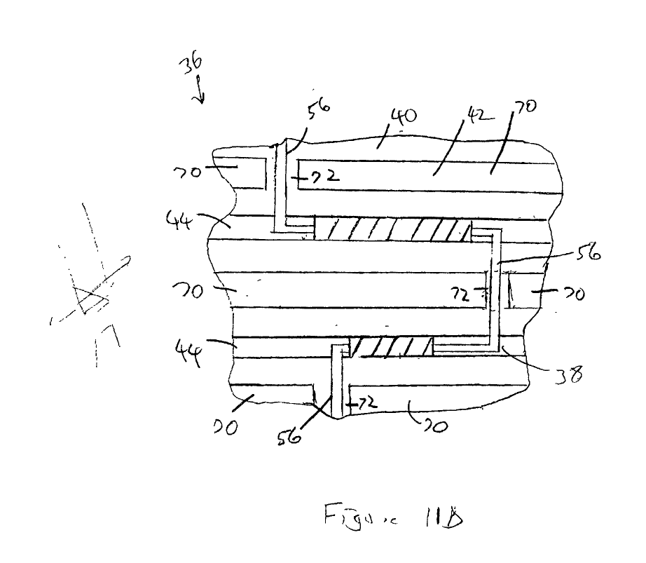

FIG. 11A through FIG. 11E illustrate component 36 constructions that can increase isolation of adjacent array waveguides 26. This isolation is often desired due to the close proximity of the array waveguides 26. The close proximity can permit the electrical or thermal effects in one array waveguide 26 to influence the performance of adjacent array waveguides 26. The close proximity can permit the electrical or thermal effects in one array waveguide 26 to influence the performance of adjacent array waveguides 26 and can also reduce the power consumption. For instance, when thermal energy flows freely through the light transmitting medium 40, temperature changes to one array waveguide 26 can flow through the light transmitting medium 40 and affect the temperature of adjacent array waveguides 26. Silicon has a thermal conductivity is about 1.5 W/ cm/° C. while silica has a thermal conductivity of about 0.014 W/ cm/° C. Accordingly, thermal energy flows more freely through silicon than it does through silica.

FIG. 11A illustrates array waveguides 26 having an isolation groove 70 positioned between adjacent array waveguides 26. The isolation groove 70 extends through the light transmitting medium 40 to the base 42. The isolation groove 70 effectively increases the distance that thermal or electrical energy must travel from one array waveguide 26 in order to affect another array waveguide 26. Although the isolation groove 70 is illustrated as extending through the light transmitting medium 40, the isolation groove 70 can extend only part way through the light transmitting medium 40.

FIG. 11B illustrate an embodiment of array waveguides 26 having an isolation groove 70 extends through the light transmitting medium 40 and into the base 42. As a result, the length of the path available for energy to travel between array waveguides 26 is further increased above the path length of the embodiment shown in FIG. 11A. Increasing this path length increase the degree of isolation between the array waveguides 26.

FIG. 11C illustrate another embodiment of array waveguides 26 having an isolation groove 70 extends through the light transmitting medium 40 and into the base 42. The isolation groove 70 undercuts the light transmitting medium 40. The undercut reduces the size of the path that is available for thermal or electrical energy to travel from one array waveguide 26 into another array waveguide 26 from the size of the available path in FIG. 11B.

FIG. 11D is a topview of the components 36 shown in FIG. 11A through 10C when each array waveguide 26 includes an effective length tuner 28. A bridge region 72 bridges the isolation groove 70 between adjacent array waveguides 26. The bridge region can extend to the bottom of the isolation groove. Alternatively, the degree of isolation provided by an isolation groove can be enhanced by forming a gap between a bottom of the bridge region and the bottom of the isolation groove.

The electrical conductor 56 is formed on the bridge region 72. Accordingly, the bridge region 72 prevents the need to form the electrical conductor 56 in the isolation groove 70. FIG. 11E is a topview of the component 36 shown in FIG. 11A through FIG. 11C when the effective length tuners 28 are incorporated into a common effective length tuner 52 positioned adjacent to more than one array waveguide 26. The bridge region 72 is constructed so as to support a wedge shaped common effective length tuner 52.

The bridge region 72 can be eliminated when electrical conductors 56 do not need to be formed between adjacent array waveguides 26. For instance, when the effective length tuners 28 are independently controlled the electrical conductors 56 can directly connect each effective length tuner 28 to the controller 30. As a result, there is no need for electrical conductors 56 to connect adjacent effective length tuners 28 and the bridge region 72 can be eliminated.

The isolation grooves can also reduce the amount of cross talk associated with the component. A common source of cross talk is light signals exiting the light signal carrying region of one waveguide and entering another waveguide. Positioning the isolation grooves between waveguides can prevent the light signals from entering other waveguides.

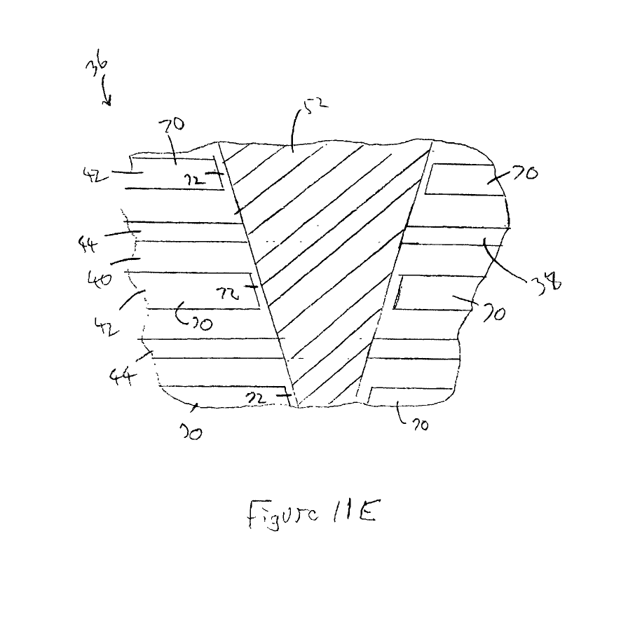

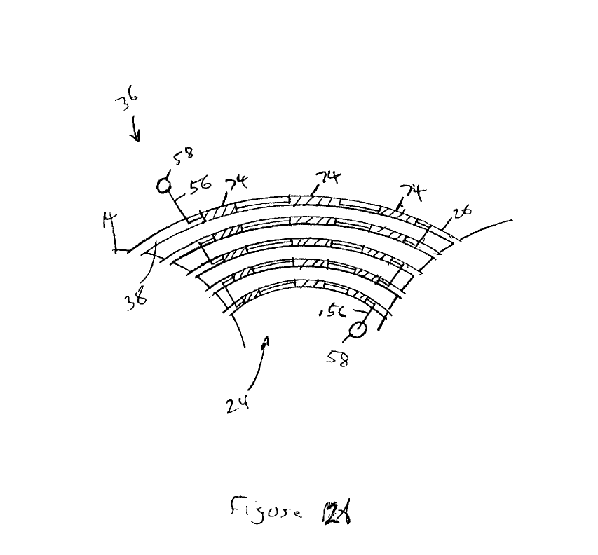

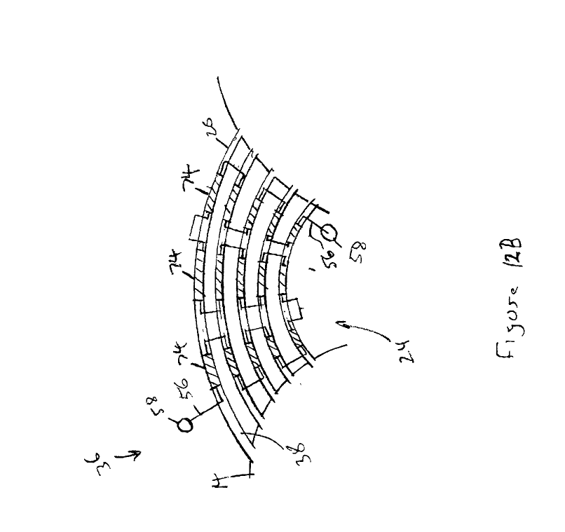

An effective length tuner 28 can be broken into a plurality of sub-effective length tuners 74 as shown in FIG. 12A. The electrical conductors 56 connect the sub-effective length tuners 74 in series. In some instances, breaking the effective length tuners 28 into smaller portions may increase the isolation between adjacent array waveguides 26 because each sub-effective length tuner 74 affects a smaller region of the component 36 than does an effective length tuner 28. Although each of the array waveguide 26 is shown as having the same number of sub-effective length tuners 74, different array waveguides 26 can have different numbers of effective length tuners 28. For instance, the shortest waveguide 38 can have a single sub-effective length tuner 74.

FIG. 12B illustrates another embodiment of the sub effective length tuners connected in series. The sub effective length tuners each connect sub effective length tuners on adjacent array waveguides. This arrangement can provide an improved thermal or electrical uniformity across the lengths of the array waveguides.

The array waveguides 26 can each include more than one effective length tuner 28 as shown in FIG. 12C. The effective length tuners 28 are operated in groups 76. For instance, the effective length tuners 28 of a first group 76A are connected in series and the effective length tuners 28 of a second group 76B are connected in series. The groups 76 can be operated independently of one another. For instance, the effective length tuners 28 of the first group 76A can be operated while the effective length tuners 28 of the second group 76B remain dormant. Once the effective length tuners 28 of the first group 76A do not provide sufficient tuning range, the effective length tuners 28 of the second group 76B can be operated so as to provide additional tuning range. In some instances, this method of operation can reduce the power requirements of the filter 10. Further, the effective length tuners can be configured such that different groups have different wavelength tuning ranges. For example, an effective length tuner 28 from the first group 76A and an effective length tuner 28 from the second group 76B positioned on the same array waveguide can have different effective area 50 lengths. The group that is employed during tuning can be the group that has the desired tuning range or both groups can be operated together.

The second group 76B can be inverted relative to the first group 76A as shown in FIG. 12D. The effective length tuners 28 in the first group 76A cause the amount of effective length change to increase with increasing array waveguide 26 length and the effective length tuners 28 in the second group 76B cause the amount of effective length change to decrease with increasing array waveguide 26 length. As a result, when the effective length tuners 28 in the first group 76A are and the second group 76B are the same, i.e. the effective length tuners in the first group 76A and in the second group 76B are resistive heaters, one group can be engaged so as shift a light signal away from a reference position on the output side in a first direction and the other group can be engaged so as shift the light signal away from the reference position in a second direction. As noted above, the ability to shift the light signals in a first direction or a second direction relative to the reference position provides the filter with an increased tuning range.

The effective length tuners illustrated in FIG. 12D can be integrated into a common effective length tuner.

The array waveguide grating 24 can include more than one type of effective length tuner 28. For instance, FIG. 12E illustrates an array waveguide grating 24 having a first group 76A of effective length tuners 28 including temperature controlled devices and a common effective length tuner. The common effective length tuner can include electrical contacts or a temperature control device. The first group 76A and the second group 76B can be operated independently or in conjunction so as to optimize the performance of the filter 10. For instance, the second group 76B can be operated until the effects of free carrier absorption are evident. The first group 76A can then be engaged to provide additional tuning range.

For the purposes of illustration, the second group 76B is shown as inverted relative to the first group 76A. When the first group 76A is operated so as to increase the temperature, the effective length of the array waveguides 26 increases causing the effective length differential, ΔL, to increase. When the second group 76B is operated so an electrical current flows between the first and second electrical contacts 64B, the effective length of the array waveguides 26 decreases. Because the second group 76B is inverted relative to the first group 76A, decreasing the effective length of the array waveguides 26 also causes the effective length differential to increase. As a result, when the first group 76A and the second group 76B are concurrently operated as described, they can increase the tuning range by acting together to increase the effective length differential.

The need to invert the second group 76B relative to the first group 76A can be eliminated by operating the effective length tuners 28 of the first group 76A so as to reduce the temperature or by operating the second group 76B so an electrical field is formed. Alternatively, there are circumstances where it is desired for the different groups 76 to be operated so as to have opposing effects on the effective length differential as explained in conjunction with FIG. 12D.

Although not illustrated, the effective length tuners 28 can include a temperature control device 54 positioned over an electrical contact 64. This arrangement can provide an increased tuning range over what could be achieved with either type of effective length tuner 28 alone. When the temperature controlled device is a resistive heater, an electrical insulator can be positioned between the electrical contact 64 and the resistive heater.

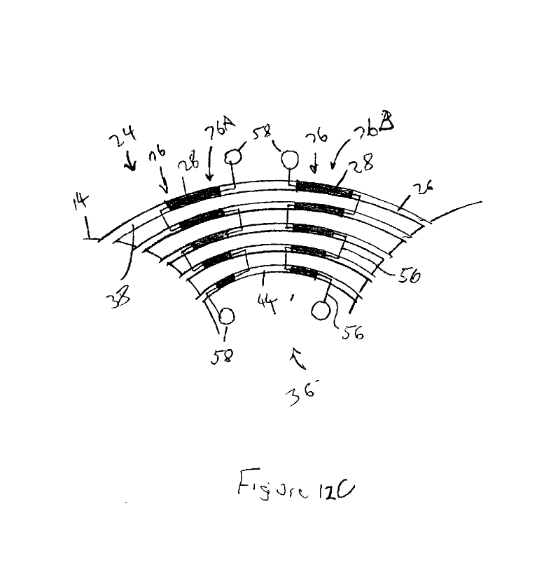

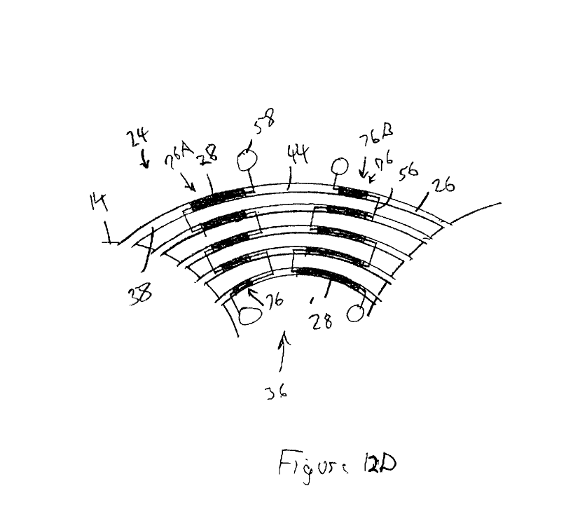

The base 42 can have a variety of constructions. FIG. 13A illustrates a component 36 having a base 42 with a light barrier 80 positioned over a substrate 82. The light barrier 80 serves to reflect the light signals from the light signal carrying region 46 back into the light signal carrying region 46. Suitable light barriers 80 include material having reflective properties such as metals. Alternatively, the light barrier 80 can be a material with a different index of refraction than the light transmitting medium 40. The change in the index of refraction can cause the reflection of light from the light signal carrying region 46 back into the light signal carrying region 46. A suitable light barrier 80 would be silica when the light carrying medium and the substrate 82 are silicon. Another suitable light barrier 80 would be air or another gas when the light carrying medium is silica and the substrate 82 is silicon. A suitable substrate 82 includes, but is not limited to, a silicon substrate 82.

The light barrier 80 need not extend over the entire substrate 82 as shown in FIG. 13B. For instance, the light barrier 80 can be an air filled pocket formed in the substrate 82. The pocket 84 can extend alongside the light signal carrying region 46 so as to define a portion of the light signal carrying region 46.

In some instances, the light signal carrying region 46 is adjacent to a surface 86 of the light barrier 80 and the light transmitting medium 40 is positioned adjacent to at least one side 88 of the light barrier 80. As a result, light signals that exit the light signal carrying region 46 can be drained from the waveguide 38 as shown by the arrow labeled A. These light signals are less likely to enter adjacent array waveguide 26. Accordingly, these light signals are not a significant source of cross talk.

The drain effect can also be achieved by placing a second light transmitting medium 90 adjacent to the sides 88 of the light barrier 80 as indicated by the region below the level of the top dashed line or by the region located between the dashed lines. The drain effect is best achieved when the second light transmitting medium 90 has an index of refraction that is greater than or substantially equal to the index of refraction of the light transmitting medium 40 positioned over the base 42. In some instances, the bottom of the substrate 82 can include an anti reflective coating that allows the light signals that are drained from a waveguide 38 to exit the component 36.

When the component 36 includes isolation grooves 70, the isolation grooves 70 can be spaced apart from the sides 88 of the light barrier 80. For instance, the second light transmitting medium 90 can be positioned between a side 88 of the light barrier 80 and the isolation groove 70.

The input waveguide 12, the array waveguides 26 and/or the output waveguide 16 can be formed over a light barrier 80 having sides 88 adjacent to a second light transmitting medium 90.

The drain effect can play an important role in improving the performance of the filter 10 because there are a large number of waveguides 38 formed in close proximity to one another. The proximity of the waveguides 38 tends to increase the portion of light signals that act as a source of cross talk by exiting one waveguide 38 and entering another. The drain effect can reduce this source of cross talk.

Other base 42 and component 36 constructions suitable for use with a filter 10 according to the present invention are discussed in U.S. patent application Ser. No. 09/686,733, filed on Oct. 10, 2000, entitled “Waveguide Having a Light Drain” and U.S. patent application Ser. No. 09/784,814, filed on Feb. 15, 2001, entitled “Component Having Reduced Cross Talk” each of which is incorporated herein in its entirety.

The construction of the base 42 can affect the performance and/or the selection of the effective length tuner 28. For instance, electrical current does not readily flow through air. As a result, when the light barrier 80 is constructed from air and the base 42 is constructed as shown in FIG. 13B, the change in the index of refraction appears as shown by the lines labeled A in FIG. 13C.

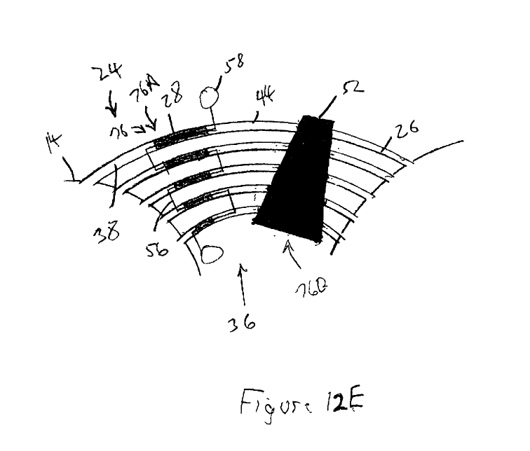

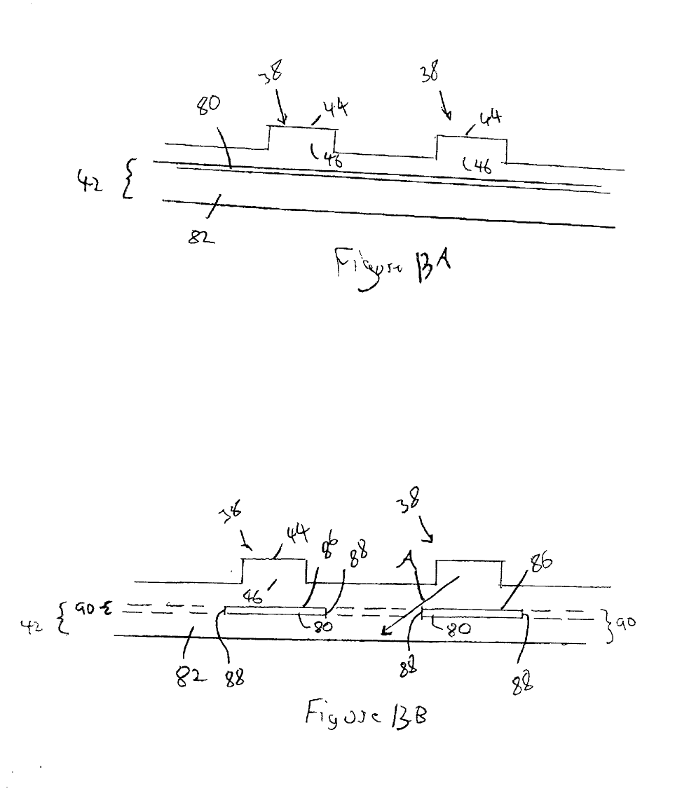

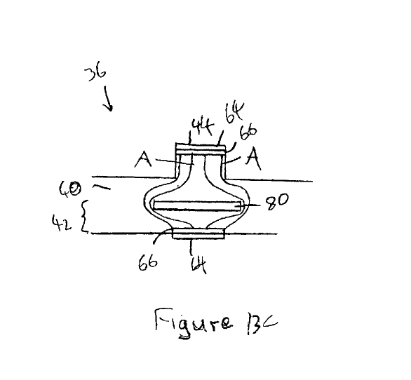

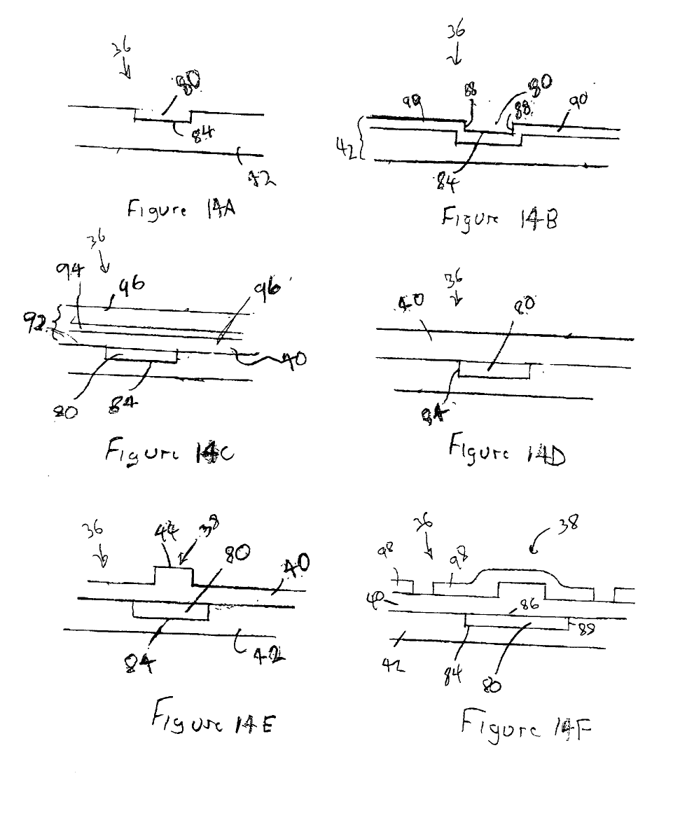

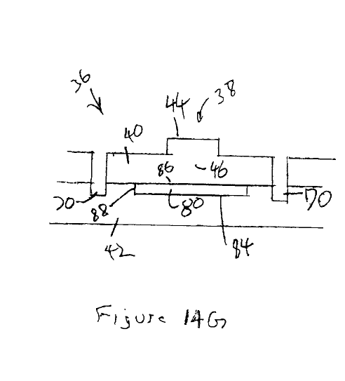

FIG. 14A to FIG. 14G illustrate a method for forming a component 36 having a filter 10. A mask is formed on a base 42 so the portions of the base 42 where a light barrier 80 is to be formed remain exposed. A suitable base 42 includes, but is not limited to, a silicon substrate. An etch is performed on the masked base 42 to form pockets 84 in the base 42. The pockets 84 are generally formed to the desired thickness of the light barrier 80.

Air can be left in the pockets 84 to serve as the light barrier 80. Alternatively, a light barrier 80 material such as silica or a low K material can be grown or deposited in the pockets 84. The mask is then removed to provide the component 36 illustrated in FIG. 14A.

When air is left in the pocket 84, a second light transmitting medium 90 can optionally be deposited or grown over the base 42 as illustrated in FIG. 14B. When air will remain in the pocket 84 to serve as the light barrier 80, the second light transmitting medium 90 is deposited so the second light transmitting medium 90 is positioned adjacent to the sides 88 of the light barrier 80. Alternatively, a light barrier 80 material such as silica can optionally be deposited in the pocket 84 after the second light transmitting medium 90 is deposited or grown.

The remainder of the method is disclosed presuming that the second light transmitting medium 90 is not deposited or grown in the pocket 84 and that air will remain in the pocket 84 to serve as the light barrier 80. A light transmitting medium 40 is formed over the base 42. A suitable technique for forming the light transmitting medium 40 over the base 42 includes, but is not limited to, employing wafer bonding techniques to bond the light transmitting medium 40 to the base 42. A suitable wafer for bonding to the base 42 includes, but is not limited to, a silicon wafer or a silicon on insulator wafer 92.

A silicon on insulator wafer 92 includes a silica layer 94 positioned between silicon layers 96 as shown in FIG. 14C. The top silicon layer 96 and the silica layer 94 can be removed to provide the component 36 shown in FIG. 14D. Suitable methods for removing the top silicon layer 96 and the silica layer 94 include, but are not limited to, etching and polishing. The bottom silicon layer 96 remains as the light transmitting medium 40 where the waveguides 38 will be formed. When a silicon wafer is bonded to the base 42, the silicon wafer will serve as the light transmitting medium 40. A portion of the silicon layer 96 can be removed from the top and moving toward the base 42 in order to obtain a light transmitting medium 40 with the desired thickness.

A silicon on insulator wafer can be substituted for the component illustrated in FIG. 14D. The silicon on insulator wafer preferably has a top silicon layer with a thickness that matches the desired thickness of the light transmitting medium. The remainder of the method is performed using the silicon on insulator wafer in order to create an optical component having the base shown in FIG. 13A.

The light transmitting medium 40 is masked such that places where a ridge 44 is to be formed are protected. The component 36 is then etched to a depth that provides the component 36 with ridges 44 of the desired height as shown in FIG. 14E.

When the component 36 is to include isolation trenches, a mask 98 is formed on the component 36 so the regions where isolation trenches are to be formed remain exposed as shown in FIG. 14F. An etch is then performed to the desired depth of the isolation trenches. The mask 98 is then removed to provide the component 36 illustrated in FIG. 14G. When the light transmitting medium 40 is to be undercut as shown in FIG. 11C, an anisotropic etch can be performed so as to form the undercut. The anistropic etch can be performed before the mask shown in FIG. 14F is removed.

As shown in FIG. 1B, the filter 10 can be constructed such that the array waveguides 26 include a reflector 34. A suitable method for forming a reflector 34 is taught in U.S. patent application Ser. No. 09/723,757, filed on Nov. 28, 2000, entitled “Formation of a Reflecting surface on an Optical Component” and incorporated herein in its entirety.

When the component 36 will include a cladding 48, the cladding 48 can be formed at different places in the method. For instance, the cladding 48 can be deposited or grown on the component 36 of FIG. 14E. Alternatively, the cladding 48 can be deposited or grown on the component 36 of FIG. 14G.

Any doped regions 66 to be formed on the ridge 44, adjacent to the ridge 44 and/or under the ridge 44 can be formed using techniques such as impurity deposition, implantation or impurity diffusion. The electrical contacts 64 can be formed adjacent to the doped regions 66 by depositing a metal layer adjacent to the doped regions 66. Any metal layers to be used as temperature control devices 54 can be grown or deposited on the component 36. Doped regions 66, electrical contact 64, electrical conductors 56, pads 58 and/or metal layers can be formed at various points throughout the method and are not necessarily done after the last etch. Suitable electrical conductors 56 and pads 58 include, but are not limited to, metal traces.

The etch(es) employed in the method described above can result in formation of a facet and/or in formation of the sides 62 of a ridge of a waveguide 38. These surfaces are preferably smooth in order to reduce optical losses. Suitable etches for forming these surfaces include, but are not limited to, reactive ion etches, the Bosch process and the methods taught in U.S. patent application Ser. No. (not yet assigned); filed on Oct. 16, 2000; and entitled “Formation of a Smooth Vertical Surface on an Optical Component” which is incorporated herein in its entirety.

All of the array waveguides 26 need not include an effective length tuner 28. As noted above, the effective length tuners are operated so the effective length change differential, δ1, is the same for adjacent pairs of array waveguides. This condition can be met without the shortest array waveguide 26 having an effective length tuner 28 or without the longest array waveguide 26 having an effective length tuner 28. The tuning range can be increased when one of the array waveguides 26 does not include an effective length tuner 28. For instance, an increased tuning range is achieved when the shortest array waveguide 26 does not have an effective length tuner 28 and an effective length tuner 28 extends the entire length of the longest array waveguide 26.

In the embodiments illustrated above, the effective length tuners 28 are shown as being positioned adjacent to a portion of the length of the array waveguides 26, however, the effective length tuners 28 can be positioned adjacent to the entire length of one or more of the array waveguides 26. Additionally, the effective length tuners 28 need not have an effective are positioned adjacent to the first light distribution component 14 and/or the second light distribution component 18. As a result, the effective length tuners 28 need not change the optical characteristics of the first light distribution component 14 and/or the second light distribution component 18.

Many of the effective length tuners 28 are shown as being positioned adjacent to a curved region of an array waveguide 26. However, each array waveguide 26 can include one or more straight sections and the effective length tuners 28 can be positioned along these straight sections.

Many of the arrayed waveguide 38 gratings 24 above are illustrated as having six or fewer array waveguides 26 for the purposes of illustration. Array waveguide gratings 24 according to the invention can include tens to hundreds of array waveguides 26.

Although the above descriptions describe all of the effective length tuners operated so as to increase the length of the array waveguides or all of the effective length tuners operated so as to decrease the length of the array waveguides, the above principles can be achieved while operating a portion of the effective length tuners so as to increase the length of the array waveguides while concurrently operating another portion of the effective length tuners operated so as to decrease the length of the array waveguides.

Although the invention is disclosed in the context of optical components having ridge waveguides, the principles of the invention can be extended to optical components that include other waveguide types such as buried channel waveguides and strip waveguides.

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings.

1. An optical filters, comprising:
an array waveguide grating having a plurality of array waveguides, each array waveguide configured to receive a portion of an input light signal and output the portions of the light signal such that the portions of the light signal are combined into an output light signal diffracted at an angle; and
effective length tuners configured to change an effective length of a plurality of the array waveguides, the effective length tuners configured to be engaged such that an angle at which the output light signal travels away from the array waveguide grating shifts relative to a reference angle, the reference angle being the angle at which the output light signal travels away from the array waveguide grating when the one or more effective length tuners are not engaged.

2. The filter of claim 1, wherein the effective length tuners are configured to be engaged such that the diffraction angle of the output light signal can be shifted away from the reference angle in a first direction or in a second direction.

3. The filter of claim 2, wherein the array waveguides have different lengths and the effective length tuners are configured to be engaged such that the amount of effective length change increases with increasing array waveguide length or such that the amount of effective length decreases with increasing array waveguide length.

4. The filter of claim 3, further comprising:
electronics for engaging the effective length tuners such that the amount of effective length change increases with increasing array waveguide length.

5. The filter of claim 4, further comprising:
electronics for engaging the effective length tuners such that the amount of effective length change decreases with increasing array waveguide length.

6. The filter of claim 1, wherein at least two of the effective length tuners are each connected in series with one or more resistors.

7. The filter of claim 6, wherein each of the effective length tuners connected in series with one or more resistors is associated with an array waveguide, the resistance provided by the resistors connected to the effective length tuners increasing as the length of the array waveguide associated with the effective length tuner increases.

8. The filter of claim 6, wherein each of the effective length tuners connected in series with one or more resistors is associated with an array waveguide, the resistance provided by the resistors connected to the effective length tuners decreasing as the length of the array waveguide associated with the effective length tuner increases.

9. The filter of claim 1, wherein at least two of the effective length tuners are each connected in series with one or more first resistors, the first resistors and the connected effective length tuners being connected in parallel between a first line and a second line, and
at least two of the effective length tuners connected in series with a first resistor also being connected in series with one or more second resistors, the second resistors and the connected effective length tuners being connected in parallel between a first line and a third line.

10. The filter of claim 1, wherein a first group of effective length tuners has an effective area length that increases with increasing array waveguide length and a second group of effective length tuners has an effective area length that decreases with increasing array waveguide length.

11. The filter of claim 1, wherein the effective length tuners each have an effective area length that is substantially the same.

12. The filter of claim 1, wherein the effective length tuners are integrated into a common effective length tuner.

13. The filter of claim 1, wherein the array waveguide grating is defined in a light transmitting medium positioned on a base.

14. The filter of claim 14, wherein the array waveguides are configured such that input light signals having different wavelengths are diffracted at different angles.

15. An optical filter, comprising:
an array waveguide grating having a plurality of array waveguides with different lengths; and
effective length tuners configured to change an effective length of a plurality of the array waveguides, the effective length tuners configured to be engaged such that the amount of effective length change for the array waveguides increases with increasing array waveguide length or such that the amount of effective length change for the array waveguides decreases with increasing array waveguide length.

16. The filter of claim 15, wherein the array waveguides are configured to receive a portion of an input light signal and output the portions of the light signal such that the portions of the light signal are combined into an output light signal diffracted at an angle.

17. The filter of claim 15, wherein the effective length tuners are arranged such that
engaging the effective length tuners such that the amount of effective length change for an array waveguide increases with increasing array waveguide length causes the light signal to shift away from a reference angle in a first direction, and
engaging the effective length tuners such that the amount of effective length change for an array waveguide decreases with increasing array waveguide length causes the light signal to shift away from the reference angle in a second direction, the reference angle being the angle at which the light signal is diffracted when the effective length tuners are not engaged.

18. The filter of claim 15, further comprising:
electronics for engaging the effective length tuners such that the amount of effective length change increases with increasing array waveguide length or for engaging the effective length tuners such that the amount of effective length change decreases with increasing array waveguide length.

19. The filter of claim 15, wherein at least two of the effective length tuners are each connected in series with one or more resistors.

20. The filter of claim 19, wherein each of the effective length tuners is connected in series with one or more resistors is associated with an array waveguide, the resistance provided by the resistors connected to the effective length tuners increasing as the length of the array waveguide associated with an effective length tuner increases.

21. The filter of claim 19, wherein each of the effective length tuners is connected in series with one or more resistors is associated with an array waveguide, the resistance provided by the resistors connected to the effective length tuners decreasing as the length of the array waveguide associated with the effective length tuner increases.

22. The filter of claim 15, wherein at least two of the effective length tuners are each connected in series with one or more first resistors, the first resistors and the connected effective length tuners being connected in parallel between a first line and a second line, and
at least two of the effective length tuners connected in series with a first resistor also being connected in series with one or more second resistors, the second resistors and the connected effective length tuners being connected in parallel between a first line and a third line.

23. The filter of claim 15, wherein the effective length tuners each have an effective area length that is substantially the same.

24. The filter of claim 15, wherein the effective length tuners are integrated into a common effective length tuner.

25. The filter of claim 15, wherein the array waveguide grating is defined in a light transmitting medium positioned on a base.

26. An optical filter, comprising:
an array waveguide grating having array waveguides that can be associated with an array waveguide index, the value of the array waveguide index being different for each of the array waveguides and the magnitude of the difference in the value of the array waveguide index for adjacent array waveguides being equal to 1; and
effective length tuners configured to change an effective length of a plurality of the array waveguides, the effective length tuners configured to be engaged such that the amount of effective length change for the array waveguides increases with increasing array waveguide index or such that the amount of effective length change for the array waveguides decreases with increasing array waveguide index.

27. A method for operating an optical filter, comprising:
obtaining an optical component having a plurality of array waveguides;
combining portions of light signals traveling through the array waveguides into output light signal diffracted at an angle;
engaging a plurality of effective length tuners configured to change the effective length of the array waveguides, the effective length tuners engaged such that the output light signals are directed away from a reference angle in a first direction, the reference angle being the angle at which the light signals are diffracted when the effective length tuners are not engaged.

28. The method of claim 26, further comprising:
engaging a plurality of effective length tuners such that the output light signals are directed away from the reference angle in a second direction.
